(19) United States
(12) Patent Application Publication
(10) Pub. No.: US 2012/0201548 A1
(43) Pub. Date: Aug. 9, 2012

(54) IMAGE FORMING APPARATUS, CONTROL METHOD THEREFOR AND STORAGE MEDIUM

(75) Inventor: Hironobu Nakai, Komae-shi (JP)

(73) Assignee: CANON KABUSHIKI KAISHA, Tokyo (JP)

(21) Appl. No.: 13/364,844

(22) Filed: Feb. 2, 2012

(30) Foreign Application Priority Data
Feb. 8, 2011 (JP) 2011-025337

(51) Int. Cl. G03G 15/00

(52) U.S. Cl. 399/16

(57) ABSTRACT

A situation is prevented in which a sheet on which an image has been formed with a first printing material is contained in a sheet-containing unit with the front and back of the sheet being inverted, and as a result, image formation using a second printing material is performed on a surface of the sheet different from the surface thereof on which the image has been formed.

### BACKGROUND OF THE INVENTION

1. Field of the Invention

The present invention relates to an image forming apparatus that forms an image on a sheet, a control method therefor, and a storage medium.

2. Description of the Related Art

In recent years, there has been known a technique for performing image formation using special toner (developer or printing material) such as transparent (CL) toner, in addition to toner (developer or printing material) of four colors including cyan (C), magenta (M), yellow (Y), and black (K), in an image forming apparatus such as a multifunctional peripheral (Japanese Patent Laid-Open No. 2009-139721). With such an image forming apparatus, for example, the glossiness of the printing surface of a sheet can be adjusted by further performing image formation using transparent toner on the sheet on which an image has been formed using toner of four colors including C, M, Y, and K.

As a method for performing image forming processing using transparent toner with an image forming apparatus, Japanese Patent Laid-Open No. 2009-139721, for example, proposes a method for performing printing in a single image forming process using toner of five colors including C, M, Y, K, and CL. Specifically, an output result can be obtained by executing a single image forming process involving feeding a sheet from a feeding unit, forming an image on the fed sheet using toner of the five colors, and discharging the sheet.

Other methods include a method for performing image formation in two or more image forming processes. First, a user causes an image forming apparatus to execute first image forming processing using toner of four colors including C, M, Y, and K. After that, the user re-sets the sheet on which an image has been formed by the first image forming processing, in a feeding unit. Then, the user performs setting such that second image forming processing using transparent toner is to be executed, and causes the image forming apparatus to execute that image forming process. The amount of toner to be transferred to a sheet in a single image forming process is restricted by the amount of toner that can be fixed in a single operation with a fuser of the image forming apparatus. For this reason, the amount of toner to be transferred to a sheet can be increased by dividing image forming processing into two or more processes, rather than transferring toner of five colors to a sheet in a single image forming process.

However, the following problem arises if image formation is performed in two or more separate processes.

In the second or subsequent image forming processing using only transparent toner, it is necessary to perform image formation using transparent toner on the same printing surface of a sheet that has undergone single-side printing in the first image forming processing. Therefore, a user needs to contain the sheet obtained by the first image forming processing in a sheet feeding section without mistaking the front and back of the sheet However, depending on the configuration of a sheet feeding section in the image forming apparatus, the front and back of a sheet to be contained needs to be considered, and if the sheet is contained in the sheet feeding section with the front and back of the sheet being inverted, a problem arises in that image formation is performed on a surface of the sheet that is different from the surface on which the first image forming processing has been performed.

### SUMMARY OF THE INVENTION

The present invention enables realization of a mechanism that prevents a situation in which a sheet on which an image has been formed with a first printing material is contained in a sheet-containing unit with the front and back of the sheet being inverted, and as a result, image formation using a second printing material is performed on a surface of the sheet that is different from the surface on which the image has been formed.

One aspect of the present invention provides an image forming apparatus that forms an image on a sheet conveyed from any one of a plurality of sheet-containing units, comprising: an image forming unit configured to form an image using a first printing material on a first surface of the sheet conveyed from the sheet-containing unit and discharges the sheet on which the image has been formed; a specification unit configured to specify a sheet-containing unit with which, if the sheet discharged to a discharge unit is contained without the first surface and a second surface of the sheet being inverted, image formation is performed on the first surface on which the image has been formed; and a notification unit configured to notify a user of the sheet-containing unit specified by the specification unit as a sheet-containing unit to be used in image forming processing using a second printing material.

Another aspect of the present invention provides a control method for an image forming apparatus that forms an image on a sheet conveyed from any one of a plurality of sheet-containing units, the method comprising: forming an image using a first printing material on a first surface of the sheet conveyed from the sheet-containing unit and discharging the sheet on which the image has been formed; specifying a sheet-containing unit with which, if the sheet discharged to a discharge unit is contained without the first surface and a second surface of the sheet being inverted, image formation is performed on the first surface on which the image has been formed; and notifying a user of the sheet-containing unit specified in the specification step as a sheet-containing unit to he used in image forming processing using a second printing material.

Still another aspect of the present invention provides a computer-readable storage medium storing a computer program for causing a computer to execute the steps of the control method.

Further features of the present invention will be apparent from the following description of exemplary embodiments with reference to the attached drawings.

### BRIEF DESCRIPTION OF THE DRAWINGS

FIG. 1 is a diagram showing an overall configuration of a system according to a first embodiment of the present invention.

FIG. 2 is a diagram showing a hardware configuration of an MFP 100.

FIG. 3 is a diagram showing a hardware configuration of a printer unit 130.

FIG. 4 is a diagram showing a hardware configuration of a control unit 110.

FIG. 5 is a diagram showing a software configuration of the MFP 100.

FIG. 6 is a diagram showing an example of a print setting screen 601 regarding image formation using transparent toner.

FIGS. 7A and 7B are diagrams showing print setting storage tables.

FIG. 8 is a diagram showing a processing flow performed when selecting a re-feeding unit in the print setting screen 601.

FIG. 9 is a diagram showing a processing flow of first image forming processing and second image forming processing.

FIGS. 10A to 10C are diagrams showing examples of a setting screen displayed in an operation unit 140.

FIGS. 11A and 11B are diagrams showing examples of the procedure of processing performed on a print sheet.

FIGS. 12A and 12B are diagrams showing examples of the procedure of processing performed on print sheets.

FIG. 13 is a diagram showing a processing flow of determination as to the presence or absence of inversion according to a second embodiment.

FIG. 14 is a diagram showing a processing flow of determination as to the presence or absence of inversion.

FIGS. 15A and 15B are diagrams showing print-setting storage tables.

FIGS. 16A and 16B are diagrams showing print-setting storage table.

FIGS. 17A and 17B are diagrams showing examples of the procedure of processing performed on print sheets.

FIG. 18 is a diagram showing an example of the procedure of processing performed on print sheets.

FIGS. 19A and 19B are diagrams showing examples of the procedure of processing performed on print sheets.

FIG. 20 is a diagram showing an example of the procedure of processing performed on print sheets.

FIGS. 21A and 21B are diagrams showing examples of the procedure of processing performed on print sheets.

FIG. 22 is a diagram showing an example of the procedure of processing performed on print sheets.

FIGS. 23A and 235 are diagrams showing examples of the procedure of processing performed on print sheets.

FIG. 24 is a diagram showing an example of the procedure of processing performed on print sheets.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

Overall Configuration of System

The description of the present embodiment will be given assuming that an image forming apparatus is a multi-function peripheral (MFP) having a plurality of functions including, for example, a copy function and a printer function. Note that the image forming apparatus may also be a single-function peripheral (SFP) that has only a single function such as a copy function or a printer function.

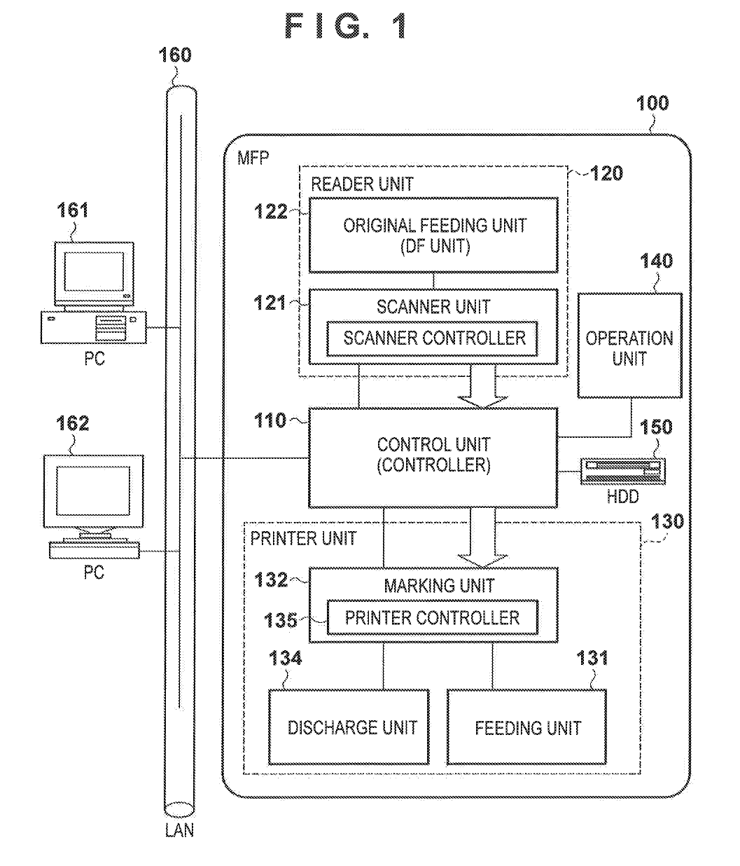

First, an exemplary configuration of the MFP 100 serving as the image forming apparatus will be described with reference to FIG. 1. A control unit (controller) 110 is electrically connected to a reader unit 120 and a printer unit 130. The control unit 110 receives data from the reader unit 120 and the printer unit 130. The control unit 110 also transmits various types of commands to the reader unit 120 and the printer unit 130. Furthermore, the control unit 110 is connected to PCs 161 and 162 via a network 160, and receives image data or control commands from these PCs. The network 160 is constructed by, for example, a local-area network.

The reader unit 120 optically reads an image of an original and converts the image into image data. The reader unit 120 includes a scanner unit 121 having the function of reading an original, and an original feeding unit 122 that conveys an original to a position where the original is readable by the scanner unit 121. A scanner controller 123 provided in the scanner unit 121 controls the scanner unit 121 and the original feeding unit 122 based on instructions from the control unit 110.

The printer unit 130 includes a feeding unit 131 that contains sheets for image formation (printing), a marking unit 132 that transfers and fixes image data to a sheet, and a discharge unit 134 that discharges a printed sheet. The printer unit 130 feeds a sheet from the feeding unit 131 to the marking unit 132, printing image data on that sheet in the marking unit 132, and thereafter discharging the sheet to the discharge unit 134 based on instructions from the control unit 110. The discharge unit 134 is capable of performing processing such as sorting or stapling on the sheets printed by the marking unit 132. The feeding unit. 131 includes a plurality of feeding units in each of which sheets are contained and placed (set) therein. For example, each feeding unit is capable of containing a plurality of types of sheets such as plain paper or glossy paper. Each feeding unit is also capable of re-containing sheets printed by the printer unit 130 of the MFP 100. Examples of the feeding units include a sheet feeding cassette, a sheet feeding deck, and a manual sheet feeding tray. The form of the feeding units is, however, not limited thereto, and other forms are also possible as long as contained sheets can be conveyed to the marking unit 132.

An operation unit 140 includes, for example, hard keys, a liquid crystal display unit, and a touch panel unit attached to the front surface of the display unit, and accepts instructions from a user through such keys or units. The operation unit 140 is also capable of displaying soft keys and the functions and state of the MFP 100 in the liquid crystal display unit. The operation unit 140 transmits commands corresponding to instructions from a user, to the control unit 110 hard disk drive (HDD) 150 stores various types of settings for the MFP 100 and image data

Based on the above-described configuration, the MFP 100 realizes various functions including, for example, a copy function, an image-data transmission function, and a printer function. 1n the case of realizing the copy function, the control unit 110 performs control that involves causing the reader unit 120 to read image data of an original and the printer unit 130 to perform printing on a sheet, using that image data. In the case of realizing the image data transmission function, the control unit 110 converts the image data of an original read by the reader unit 120 into code data and transmits that code data to the PC 161 or 162 via the network 160. Furthermore, in the case of realizing the printer function, the control unit 110 converts code data (print data) received from the PC 161 or 162 via the network 160 into image data and transmits that image data to the printer unit 130. The printer unit 130 performs printing on a sheet using the received image data

Hardware Configuration of MFP

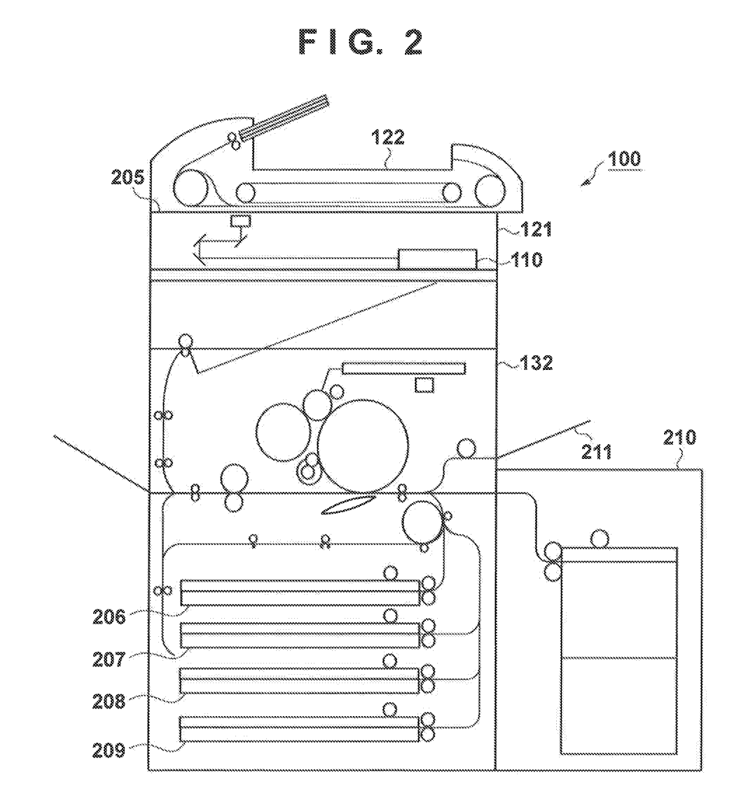

Next, an exemplary hardware configuration of the MFP 100 will be described with reference to FIG. 2. Note that in the present embodiment, a single-drum color printer, that performs color printing using a single drum will be described as an example of the MFP 100.

The original feeding unit 122 conveys an original on a glass original platen 205 so as to make the original optically readable. The scanner unit 121 transmits to the control unit 110 an optical signal that is obtained by scanning an image of an original using an image reading sensor. The control unit 110 generates an image signal using the received optical signal. The marking unit 132 executes printing on a sheet fed from a feeding unit, based on the image signal generated by the control unit 110.

The feeding unit 131 in FIG. 1 includes a plurality of feeding units including sheet feeding cassettes 206 to 209, a sheet feeding deck 210, and a manual sheet feeding tray 211, and is capable of feeding a sheet from any of the feeding units to the marking unit 132. The sheet feeding cassettes 206 to 209 each function as a second feeding unit from which a sheet is fed after having been inverted, and the sheet feeding deck 210 and the manual sheet feeding tray 211 each function as a first feeding unit from which a sheet is fed without being inverted.

Hardware Configuration of Printer Unit

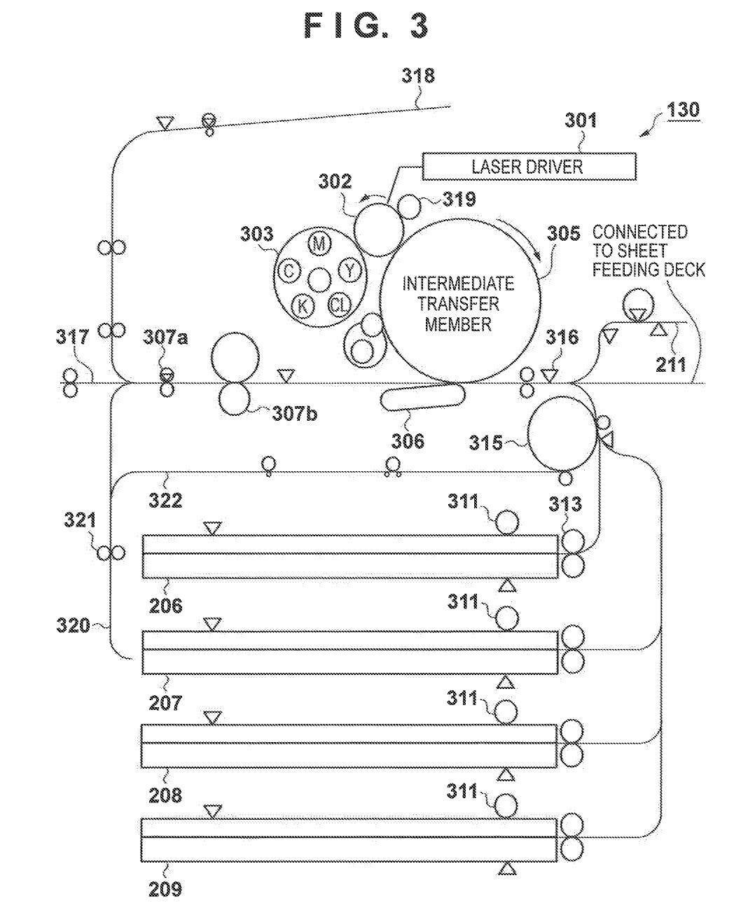

Next, an exemplary hardware configuration of the printer unit 130 will be described with reference to FIG. 3. Each unit included in the printer unit 130 is controlled by a printer controller 135. The following description briefly discusses image forming processing performed on a sheet under the control of the printer controller 135. The printer controller 135 rotates a photoconductor 302 counterclockwise in FIG. 3 and causes a charger 319 to electrically charge the front surface of the photoconductor 302, based on instructions from the control unit 110. A laser driver 301 irradiates the photoconductor 302 with laser light based on the image signal generated by the control unit 110, and forms an electrostatic latent image on the front surface of the photoconductor 302.

A developing unit. 303 develops the electrostatic latent image formed on the front surface of the photoconductor 302 using toner (printing material or developer) of a plurality of colors, based on instructions from the printer controller 135. A toner image developed on the front surface of the photoconductor 302 is transferred to an intermediate transfer member 305 that is being rotated clockwise in FIG. 3. Note that the developing unit 303 includes developing units corresponding to five colors including color toner of yellow (Y), magenta (M), cyan (C), and black (K) (first toner) and transparent toner (CL) (second toner). With the single-drum MFP 100 shown in FIG. 3, in the case of color printing, the transfer of an image to the intermediate transfer member 305 is sequentially executed for each color. Specifically, toner images that are sequentially formed by the developing unit 303 on the front surface of the photoconductor 302 are transferred overlaid at the same position on the intermediate transfer member 305 along with the rotation of the intermediate transfer member 305. As a result, a single page of color image using toner of Y, M, C, and K is formed on the front surface of the intermediate transfer member 305. Note that if printing is designated to be performed using the transparent toner (CL) as the second toner, processing for transferring a toner image of CL may also be executed in succession after the processing for transferring Y, M, C, and K toner images has been performed.

While executing the above-described image forming processing, the printer controller 135 also feeds a sheet from one of the sheet feeding cassettes 206 to 209, the sheet feeding deck 210, and the manual sheet feeding tray 211. For example, in the case of feeding a sheet from one of the sheet feeding cassettes 206 to 209, the printer controller 135 feeds a sheet by operating a pickup roller 311. The fed sheet is conveyed to the position of a conveyor roller 315 by a feed roller 313 and then conveyed to in front of a resist roller 316 by the conveyor roller 315.

The printer controller 135 conveys a sheet to a position between the intermediate transfer member 305 and a transfer belt 306 at the time when the processing for transferring color images to the intermediate transfer member 305 is complete. At that position, a single page of image formed on the intermediate transfer member 305 is transferred to the sheet by the transfer belt. 306. After that transfer processing, the printer controller 135 conveys the sheet to fixing rollers 307a and 307b, and the fixing rollers 307a and 307b fix the toner images on the sheet by applying heat and pressure. Thereafter, the printer controller 135 discharges that sheet to either a face-up discharge opening 317 from which a sheet is discharged with the printing surface thereof facing upward, or a face-down discharge opening 318 from which a sheet is discharged with the printing surface thereof facing downward. The face-up discharge opening 317 functions as a first discharge unit that discharges a sheet without inverting it, and the face-down discharge opening 318 functions as a second discharge unit that discharges a sheet after inverting it. Selecting either of these discharge openings enables the front and back of a discharging sheet to be inverted with respect to each other>Alternatively, the front and back of a sheet may be inverted with respect to each other prior to discharge of the sheet, using an inversion path 320 and an inversion roller 321, which are used in the case of double-side printing that is discussed later.

Note that, in the case of double-side printing, the printer controller 135 conveys a sheet that has undergone fixing processing to the inversion path 320, causes the inversion roller 321 to invert the front and back of the sheet, and then causes the conveyor roller 315 to again convey the sheet to in front of the resist roller 316 along a double-side path 322. Furthermore, the printer controller 135 executes image formation for forming the image of the second page (back surface) on the other surface of the sheet, using the same method as in the case of forming the image of the first page (front surface) on the one surface of the sheet. Thereafter, the printer controller 135 discharges the sheet on which images have been formed on both sides, to either the face-up discharge opening 317 or the face-down discharge opening 318. Through the above operations, the image forming processing (print processing) performed on the sheet is complete.

The operations as described above are performed by the control unit 110 executing a print job stored in the HDD 150. The print job refers to a job that associates image data to be printed with data that indicates settings of print conditions for printing the image data (e.g., single-side or double-side, or print layout settings).

Hardware Configuration of Control Unit

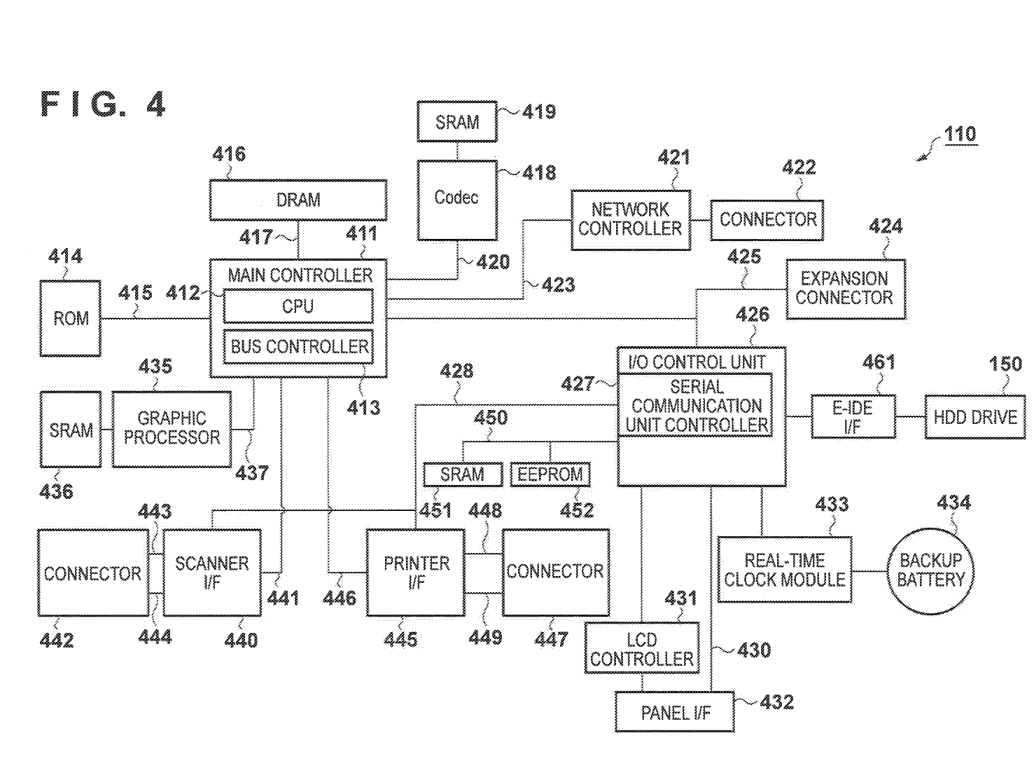

Next, an exemplary hardware configuration of the control unit 110 will be described with reference to FIG. 4. A main controller 411 includes a CPU 412, a bus controller 413, and various types of I/F controller circuits. The CPU 412 and the bus controller 413 perform centralized control of the overall operation of the control unit 110. The CPU 412 executes various types of operations based on programs that have been read from a ROM 414 via a ROM I/F 415. For example, the CPU 412 interprets code data (e.g., page description language (PDL)) received from the PC 161 or 162 shown in FIG. 1, based on such a read program. The bus controller 413 performs control relating to data transfer via each I/F, including arbitration between buses and DMA data transfer, for example.

A DRAM 416 is connected to the main controller 411 via a DRAM I/F 417, and is used as a work area for the CPU 412 to operate or an area for storing image data. A Codec 418 performs, for example, processing for compressing raster image data stored in the DRAM 416 in MH, MR, MMR, JBIG, JPEG or other format, or processing for decompressing code data stored in a compressed state into raster image data An SRAM 419 is used as a temporary work area for the Codec 418. The Codec 418 is connected to the main controller 411 via an I/F 420. Data transfer between the SRAM 419 and the DRAM 416 is controlled by the bus controller 413 and is realized by DMA transfer.

A graphic processor 435 performs processing such as image rotation, image scaling, color space conversion, or binarization on raster image data stored in the DRAM 416. An SRAM 436 is used as a temporary work area for the graphic processor 435. The graphic processor 435 is connected to the main controller 411 via an I/F 437 Data transfer between the graphic processor 435 and the DRAM 416 is controlled by the bus controller 413 and is realized by DMA transfer.

A network controller 421 is connected to the main controller 411 via an I/F 423 and connected to an external network (e,g., the network 160) via a connector 422. An expansion connector 424 for connecting an expansion board, and an I/O control unit 426 are connected to a general high-speed bus 425. The general high-speed bus 425 is, for example, a PCI bus. The I/O control unit 426 is provided with two channels of an asynchronous serial communication unit controller 427 for exchanging control commands between the respective CPUs of the reader unit 120 and the printer unit. 130.

The I/O control unit 426 is connected to a scanner I/F 440 and a printer I/F 445 via an I/O bus 428. A panel I/F 432 is an interface for exchanging data with the operation unit 140 The panel I/F 432 serves to transfer image data, which has been transferred from an LCD controller 431, to the operation unit 140. The panel I/F 432 also serves to transfer a key input signal that has been input through the hard keys or the touch panel of the operation unit 140, to the I/O control unit 426 via a key entry I/F 430.

A real-time clock module 433 receives supply of power from a backup battery 434 and updates/stores the date and time managed in the MFP 100 An E-IDE I/F 461 is an interface for connecting the HDD 150. Via the E-IDE I/F, the CPU 412 stores image data in the HDD 150 or reads image data from the HDD 150.

Connectors 442 and 447 are connected respectively to the reader unit 120 and the printer unit 130. These connectors are connected respectively to the scanner I/F 440 and the printer I/F 445 via asynchronous serial I/Fs 443 and 448 and video I/Fs 444 and 449.

The scanner 1/F 440 is connected to the reader unit 120 via the connector 442 and connected to the main controller 411 via a scanner bus 441. The scanner I/F 440 performs predetermined processing on the image received from the reader unit 120. The scanner I/F 440 also outputs to the scanner bus 441 a control signal generated based on the video control signal received from the reader unit 120. Data transfer from the scanner bus 441 to the DRAM 416 is controlled by the bus controller 413.

The printer I/F 445 is connected to the printer unit 130 via the connector 447 and connected to the main controller 411 via a printer bus 446. The printer I/F 445 performs predetermined processing on the image data output from the main controller 411 and outputs the processed image data to the printer unit 130. The transfer of raster image data expanded in the DRAM 416 to the printer unit 130 is controlled by the bus controller 413. The raster image data is DNA transferred to the printer unit 130 via the printer bus 446, the printer I/F 445, and the video I/F 449.

An SRAM 451 is a memory capable of continuously holding storage content with power supplied from a backup battery, even in a state in which the entire power supply of the MFP 100 is cut off. The SRAM 451 is connected to the I/O control unit 426 via a bus 450. Likewise, an EEPROM 452 is also a memory connected to the I/O control unit 426 via the bus 450.

Software Configuration

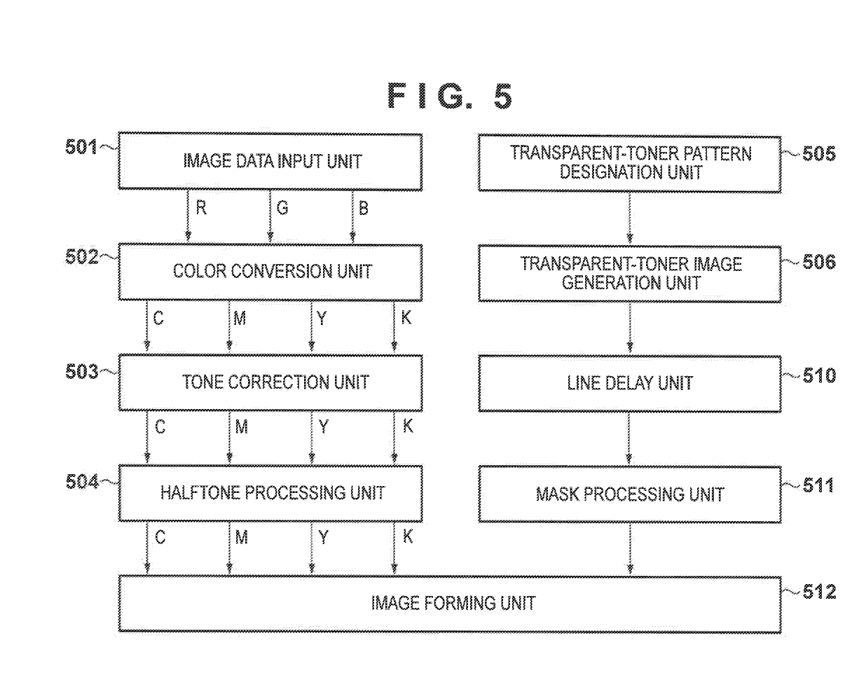

Next, a software configuration of the MFP 100 will be described with reference to FIG. 5. FIG. 5 shows functional blocks realized by the CPU 412 of the control unit 110 executing programs stored in the ROM 414, and the flow of data. In FIG. 5, an image data input unit. 501, a color conversion unit 502, a tone correction unit. 503, a halftone processing unit 504, a transparent-toner image generation unit 506, a line delay unit 510, and a mask processing unit 511 are illustrated.

The image data input unit 501 receives input of image data that has been read from an original with the reader unit 120 (or image data received from the PC 161 or 162 via the LAN 160). The CPU 412 temporarily stores the image data read with the reader unit 120 in the DRAM 416 in units of pages, and thereafter, reads out that data in units of pixels and inputs the read data into the image data input unit 501.

The image data input unit 501 divides the image data of each pixel that has been input by the CPU 412 into R, G, and B image signals, and then outputs these image signals to the color conversion unit 502. The color conversion unit 502 converts the input R, G, and B image signals into C, M, Y, and K image signals that correspond to a color space for printout, and then outputs these image signals to the tone correction unit 503. The tone correction unit 503 performs tone correction on the input image signals so that normal tone characteristics can be obtained, and then outputs the tone-corrected image signals to the halftone processing unit 504. The halftone processing unit 504 performs pseudo halftone processing on the tone-corrected image signals and then outputs these image signals to the printer unit 130.

Meanwhile, a transparent-toner pattern designation unit 505 is provided in the operation unit 140 or in the respective PCs 161 and 162. The transparent-toner pattern designation unit 505 generates setting data regarding image formation using transparent toner, based on data input from a user, and inputs that setting data to the transparent-toner image generation unit 506. The transparent-toner image generation unit 506 generates image data to be output in image formation using transparent toner, in bitmap format in accordance with the setting data, and outputs that image data as image signals of each pixel to the line delay unit 510. The line delay unit 510 delays the image signals included in the input image data, and outputs the delayed signals to the mask processing unit 511. The mask processing unit 511 performs mask processing on the input image signals, and outputs the processed image signals to an image forming unit 512 (which corresponds to the printer unit 130 in FIG. 1).

The image forming unit 512 prints C, M, Y, and K color images and a transparent toner image on a sheet, based on the image signals received from the halftone processing unit 504 and the image signals received from the mask processing unit 511.

Print Setting Screen

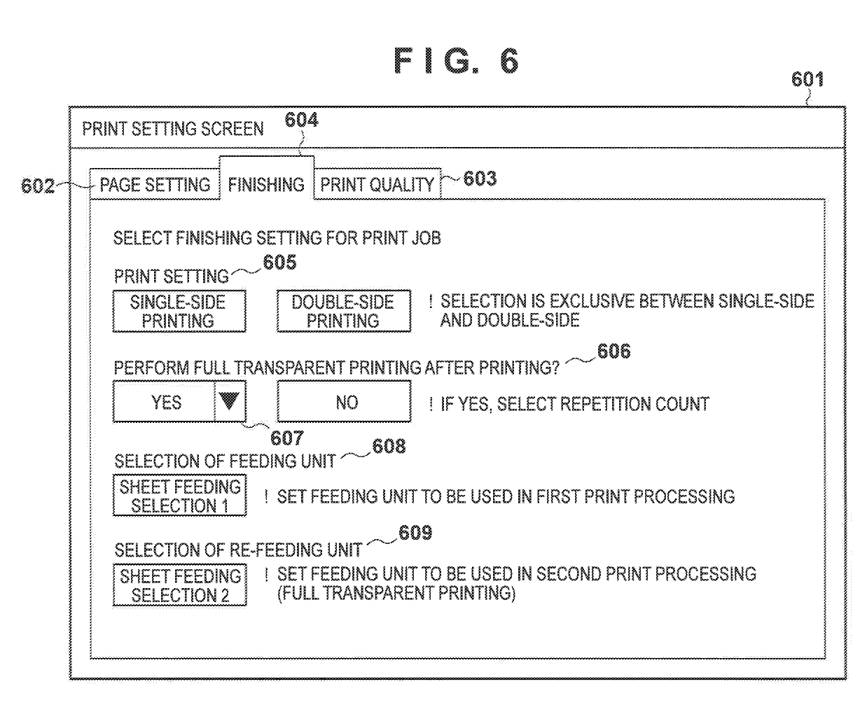

Next, an example of a print setting screen 601 for printing using the transparent toner will be described with reference to FIG. 6. The print setting screen 601 is an example of a screen displayed in a display device of the PC 161 or 162 by a printer driver installed on the PC 161 or 162. Three selectable tabs 602, 604, and 603 are displayed in the print setting screen 601.

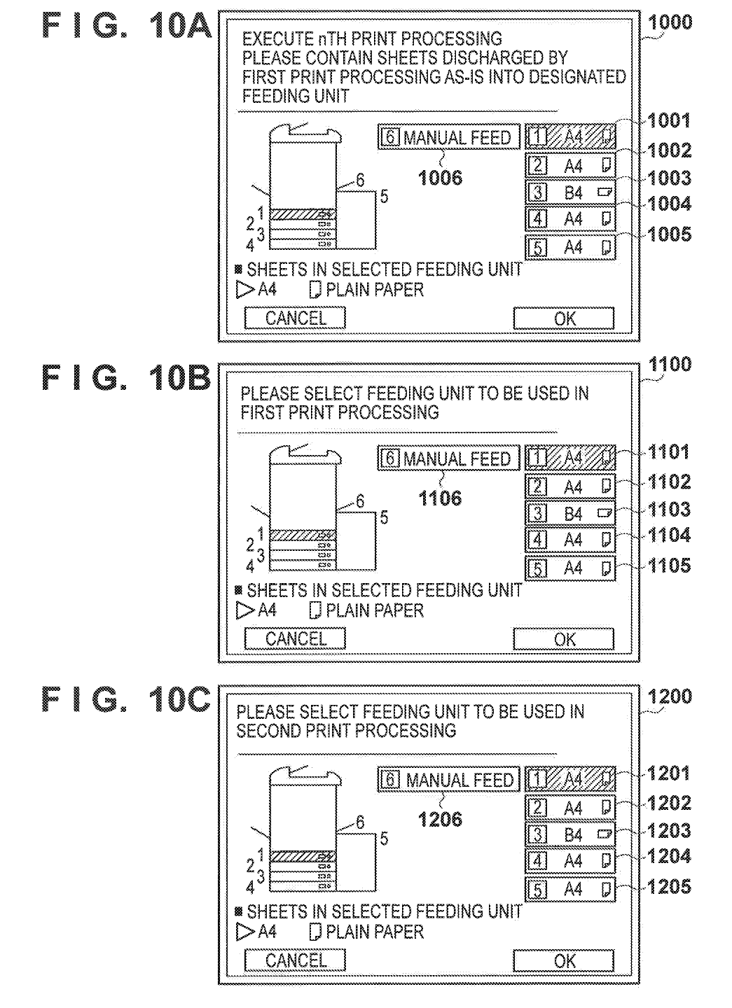

The tab 602 calls up a screen (not shown) for performing page setting of a print document, in which settings of sheet size, print orientation, enlarge/reduction rate of an original and the like are performed. The tab 603 calls up a screen (not shown) for performing print quality setting, in which settings regarding color or the like are performed in accordance with the content of an original. The tab 604 calls up a screen for performing print finishing setting. A setting item 605 is for selecting either single-side printing or double-side printing. A setting item 606 is for performing settings as to whether or not the second image forming processing using transparent toner is to be performed after printing by the first image forming processing. In the case of performing image formation using transparent toner, a processing execution count is selected from a pull-down menu in a setting item 607. A setting item 608 is for selecting a feeding unit to be used to supply sheets when performing the first image forming processing. If the “Sheet Feeding Selection 1” button is pressed, the screen transitions to a screen for selecting a feeding unit to be used in the first image forming processing (see FIG. 10B). A selling item. 609 is for selecting a feeding unit to be used to supply sheets when performing the second image forming processing if the “Sheet Feeding Selection 2” button is pressed, the screen transitions to a screen for selecting a feeding unit to he used in the second image forming processing (see FIG. 10C).

Print-Setting Storage Table

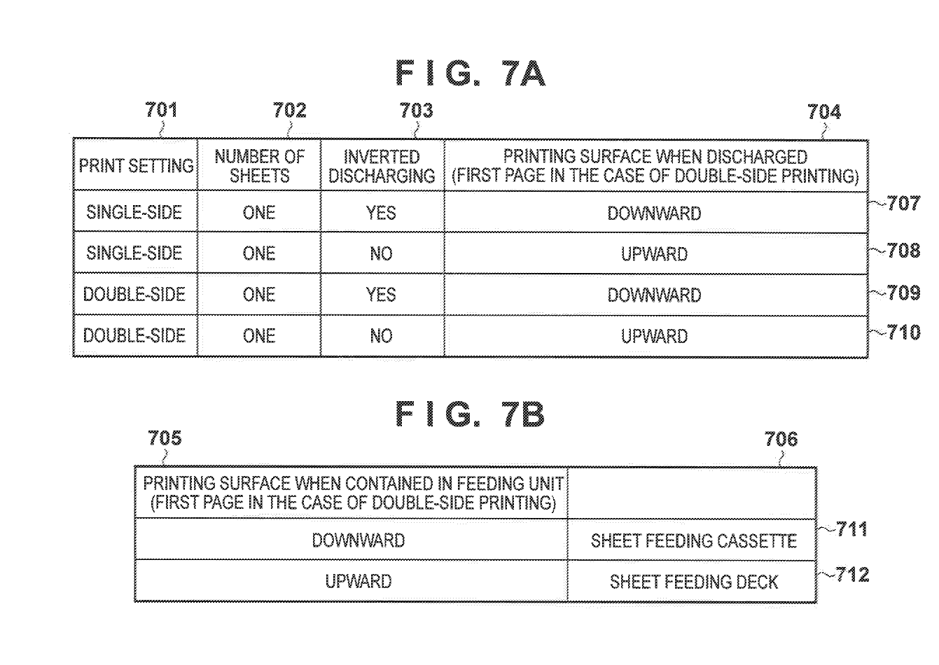

FIGS. 7A and 78 are diagrams illustrating the relationship between a feeding unit, a re-feeding unit, and a printing surface of the discharged sheet. An item field 701 indicates either single-side printing or double-side printing, which has been set in the print setting. An item field 702 indicates the number of sheets of an original. An item field 703 indicates he form of discharge of sheets that have undergone image forming processing, that is, whether the face-up discharge opening 317 indicated as “NO” for inverted output has been selected or the face-down discharge opening 318 indicated as “YES” for inverted output has been selected. An item field 704 indicates which side the printing surfaces of sheets face when discharged. Note that in the case of double-side printing, the printing surface of the sheet of the first page is indicated. An item field 705 indicates which side of sheets that have been set in the feeding unit is the printing surface. An item field 706 indicates whether the feeding unit 206, 207, 208, or 209 provided in the main body, the sheet feeding deck 210, or the manual sheet feeding tray 211 is the source of supply.

Data 707 indicates that in the case where single-side printing and inverted sheet discharging are performed using a single sheet, the printing surface of the discharged sheet faces downward. Similarly, other data pieces 708, 709, and 710 also indicate which side the printing surfaces of discharged sheets face along with the combination of print settings. Data 711 indicates that in the case of the sheet feeding cassette 206, the downward-facing surfaces of sheets set in the cassette will be the printing surfaces, based on the positional relationship between the sheet feeding cassette 206 and the intermediate transfer member 305 in FIG. 3. Similarly, data 712 indicates which side will be the printing surface in the case of the external sheet feeding deck 210.

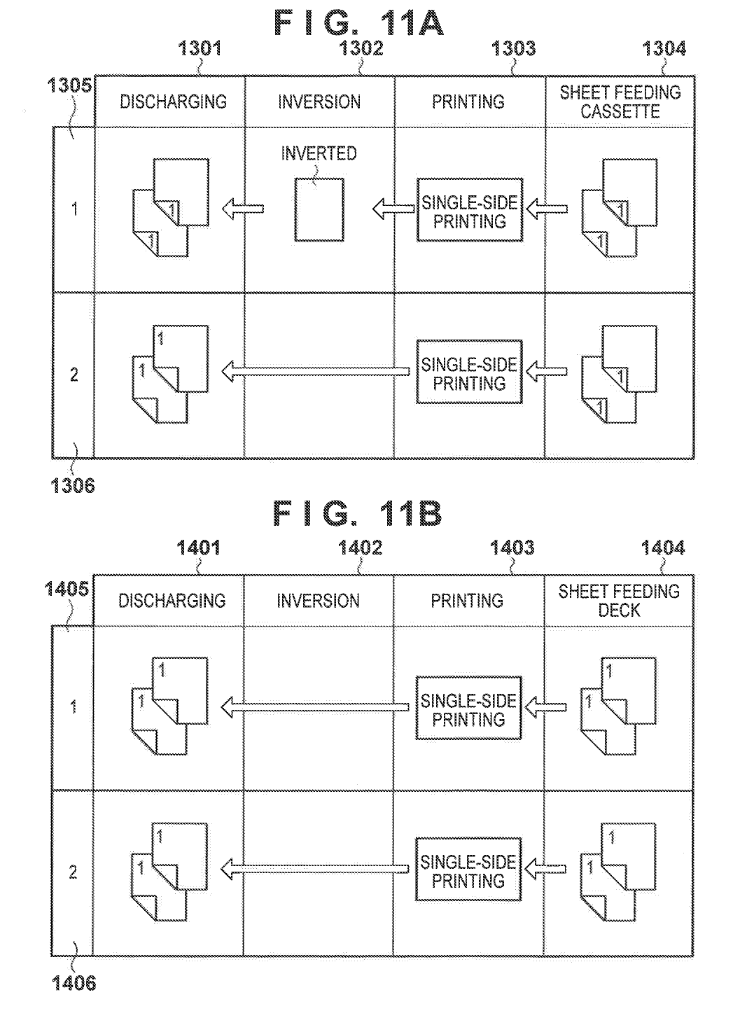

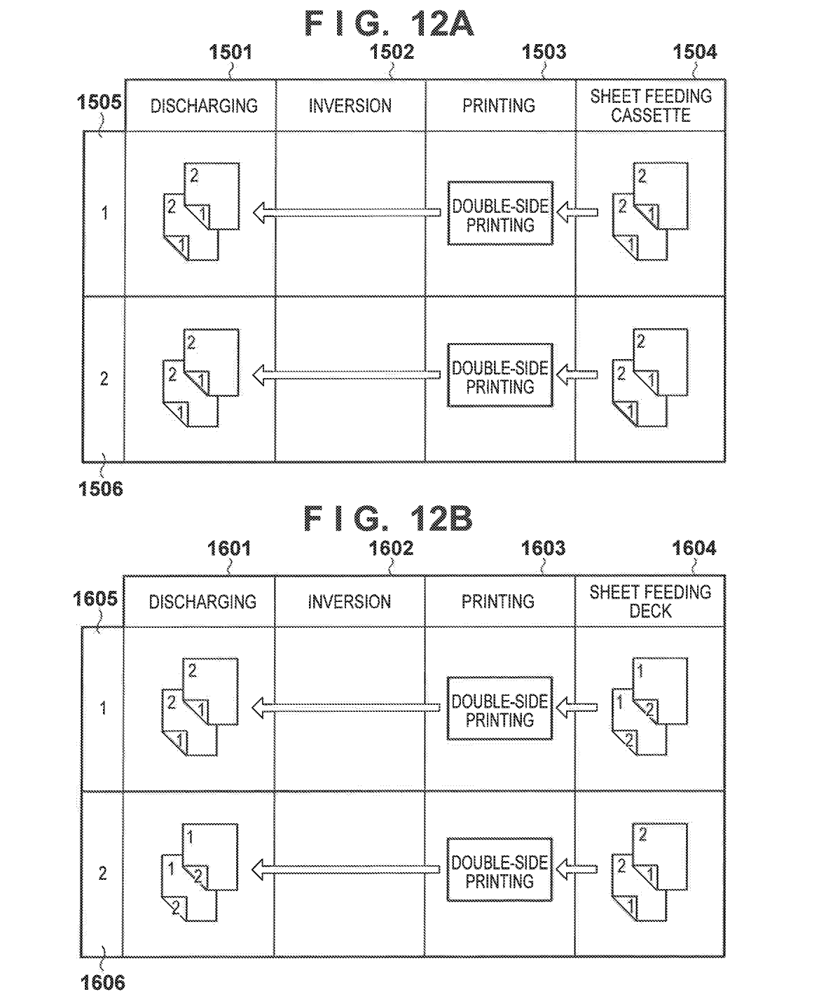

In order to facilitate understanding of the above description of FIGS. 7A and 7B, a further detailed description will be given with reference to FIGS. 11A, 11B, 12A, and 12B. In FIG. 11A, an item field 1301 schematically indicates the printing surfaces of sheets when discharged. An item field 1302 indicates whether or not the fronts and backs of the sheets are to be inverted at the time of sheet discharging to the face-up discharge opening 317 An item field 1303 indicates either single-side print processing or double-side print processing. If double-side printing is indicated in the item field 1303, it means that the sheets that have undergone double-side printing are transferred to the item field 1302. An item field 1304 indicates the type of the feeding unit to be used in the MFP 100 of the present embodiment. Data 1305 schematically indicates the correspondence between the flow of sheets and the printing surfaces of the sheets when the first image forming processing according to the data 707 has been performed. Data 1306 schematically indicates the correspondence between the flow of sheets and the printing surfaces of the sheets when the second image forming processing according to the data 711 has been performed.

In FIG. 11B, an item field 1401 schematically indicates the printing surfaces of sheets when discharged. An item field 1402 indicates whether or not the fronts and backs of the sheets are to be inverted at the time of sheet discharging to the face-up discharge opening 317. An item field 1403 is for distinguishing between single-side print processing and double-side print processing. If double-side printing is indicated in the item field 1403, it means that the sheets that have undergone double-side printing are transferred to the item field 1402. An item field. 1404 indicates the type of the feeding unit to be used in the MFP 100 of the present embodiment. Data 1405 schematically indicates the correspondence between the flow of sheets and the printing surfaces of the sheets when the first image forming processing according to the data 708 has been performed. Data 1406 schematically indicates the correspondence between the flow of sheets and the printing surfaces of the sheets when the second image forming processing according to the data 712 has been performed.

In FIG. 12A, an item field 1501 schematically indicates the printing surfaces of sheets when discharged. An item field 1502 indicates whether or not the fronts and backs of sheets are to be inverted at the time of sheet discharging to the face-up discharge opening 317. An item field 1503 is for distinguishing between single-side print processing and double-side print processing. If double-side printing is indicated in the item field 1503, it means that the sheets that have undergone double-side printing are transferred to the item field 1502. An item field 1504 indicates the type of the feeding unit to be used in the MFP 100 of the present embodiment. Data 1505 schematically indicates the correspondence between the flow of sheets and the printing surfaces of the sheets when the first image forming processing according to the data 709 has been performed. Data 1506 schematically indicates the correspondence between the flow of sheets and the printing surfaces of the sheets when the second image forming processing according to the data 711 has been performed.

In FIG. 12B, an item field 1601 schematically indicates the printing surfaces of sheets when discharged. An item field 1602 indicates whether or not the fronts and backs of the sheets are to be inverted at the time of sheet discharging to the face-up discharge opening 317. An item field 1603 is for distinguishing between single-side print processing and double-side print processing. If double-side printing is indicated in the item field 1603, it means that the sheets that have undergone double-side printing are transferred to the item field 1602. An item field 1604 indicates the type of the feeding unit to be used in the MFP 100 of the present embodiment. FIGS. 12A and 12B show examples where an original consisting of two pages is subjected to double-side printing.

Here, there are roughly the following two methods as the printing method using transparent toner. First is a method of performing printing using transparent toner in a single printing process, in which the MFP 100 transfers and fixes an image on a sheet in a single printing process using toner of five colors including C, M, Y, K, and CL. Second is a method of performing printing using transparent toner in two or more printing processes, in which the MFP 100 performs a first printing process in which an image is transferred and fixed on a sheet using toner of four colors including C, M, Y, and K (which corresponds to first processing, first printing processing, or first image forming processing). Next, after a user has re-set the once-discharged sheet in the feeding unit, and upon receipt of an instruction to start printing, the MFP 100 performs a second or subsequent printing process in which the sheet is fed and an image is transferred and fixed on the sheet using toner of CL (which corresponds to second processing, second printing processing, or second image forming processing).

The first method is advantageous in that only a short time is required for print processing because all five color toner images are transferred in a single printing process. However, the amount of toner that can be fixed at a time on a single sheet is restricted depending on the performance of the fuser. For this reason, the amount of transparent toner that can be fixed is restricted with the first method in which the toner of CL as well as the toner of four colors including C, M, Y, and K are fixed in a single process. On the other hand, with the second method, since only the transparent toner is fixed in the second image forming processing, the amount of the transparent toner that can be fixed can be increased as compared with the first method. Furthermore, with the second method, it is also possible by performing the second image forming processing multiple times to adopt application forms in which the protection of printing surfaces is enhanced or glossiness is further improved.

However, with the second method, when discharged sheets are set in a specific feeding unit after the first image forming processing, there are, for example, cases where the sheets have their printing surfaces on a different side as a result of the fronts and backs of the sheets being inverted, due to a difference in the form of sheet conveyance. If sheets are set in an incorrect manner, printing using transparent toner will be performed erroneously on the surface opposite to the printing surfaces of the sheets on which printing has been performed by the first image forming processing. In this case, printing has to be re-executed, requiring an extra consumption of toner of four colors including C, M, Y, and K and new sheets and thereby resulting in needless resource consumption.

In view of this, the MFP 100 according to the present embodiment enables an optimum feeding unit for sheet re-feeding to be selected in the case of executing a print lob including the first image forming processing and the second or subsequent print processing in the second image forming processing described above. Specifically, the MFP 100 makes it possible to select an optimum feeding unit for sheet re-feeding, based on the relationship between the print settings at the time of executing the first image forming processing, and the feeding units.

Processing Flow

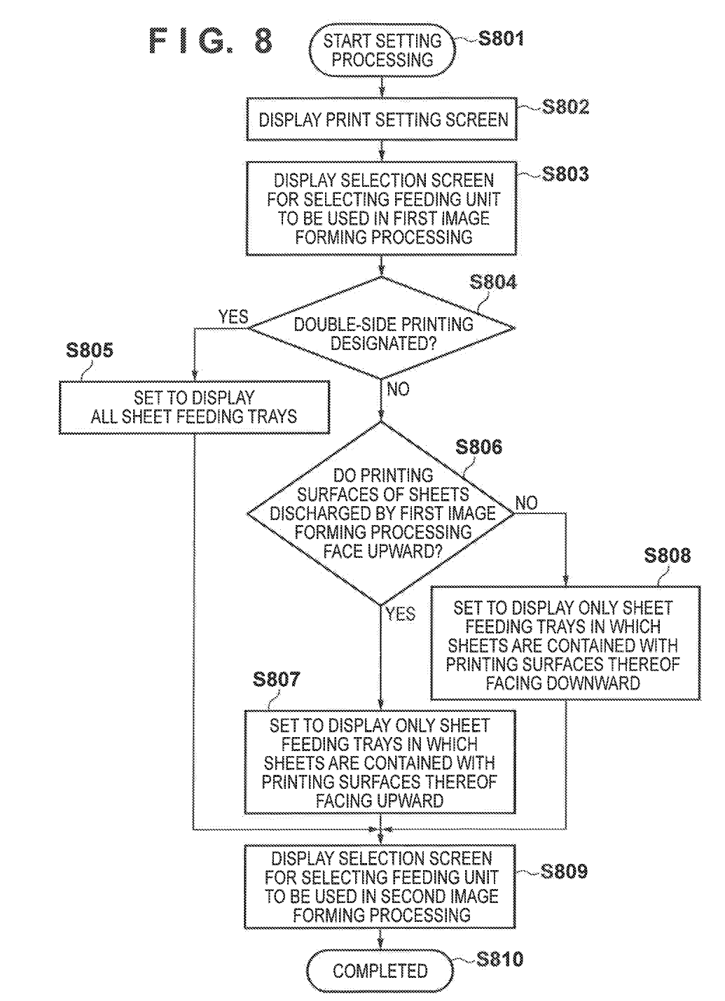

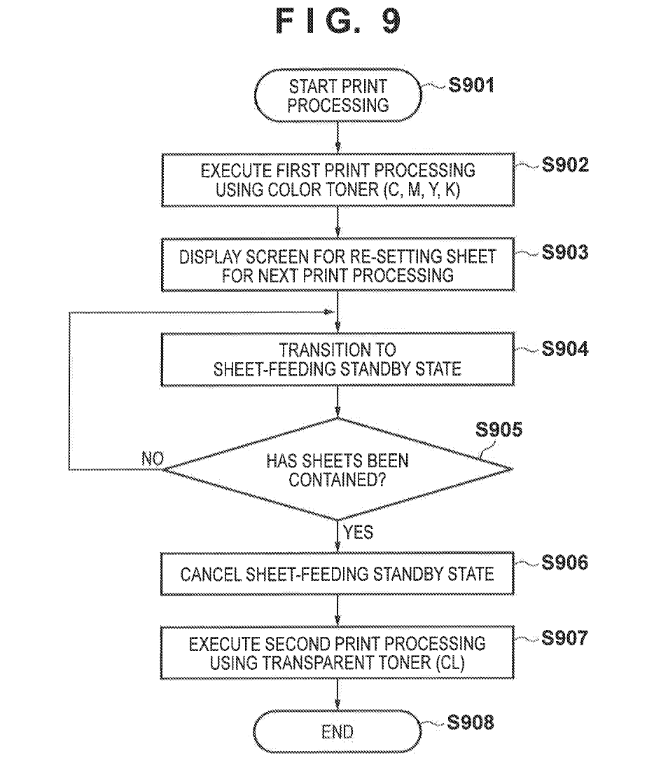

A procedure of the print processing according to the present embodiment will now be described with reference to FIGS, 8 through 12B. Note that the processing performed in each step in FIGS. 8 and 9 is realized by, for example, the CPU 412 reading out a program stored in the ROM 414 and executing that program.

First, the print setting screen 601 shown in FIG, 6 is displayed in step S801. Then, when a user presses the “Sheet Feeding Selection 1” button in the print setting screen 601, the screen transitions to a selection screen 1100 (see FIG. 10B) for selecting a feeding unit to be used in the first print processing, in step S802. In other words, a feeding unit to be used in the first image forming processing using color toner (C, M, Y, and K) is set in the selection screen 1100 (first feeding-unit setting). Buttons 1101 to 1106 that correspond to the respective feeding units provided in the MAP 100 are displayed in the selection screen 1100. For example, the buttons 1101 to 1104 correspond respectively to the sheet feeding cassettes 206 to 209, the button 1105 corresponds to the sheet feeding deck 210, and the button 1106 corresponds to the manual sheet feeding tray 211. When the user presses a button that corresponds to one of the feeding units displayed in the selection screen and then presses the OK button, a feeding unit to be used in the first image forming processing is set and the screen returns to the print setting screen in FIG. 6.

Thereafter, processing for determining feeding units to be displayed in the screen for setting a feeding unit to be used in the second images forming processing is performed (steps S804 to S808). First, in step S804, whether or not the user has designated double-side printing is determined in the print setting 605 of the print setting screen 601. If double-side printing has been set, the processing proceeds to step S805, where all the sheet feeding trays are set to be displayed in a selectable manner. If double-side printing has not been set in step S804, the processing proceeds to step S806. Then, whether or not the printing surfaces of the sheets discharged by the first image forming processing face upward is determined in step S806. The determination content is derived from the results of the respective print settings indicated by 707 to 710 already shown in FIG. 7A. If the determination result in step S806 shows that the printing surfaces face upward, the processing proceeds to step S807. In step S807, setting is performed such that only sheet feeding trays in which sheets are set with the printing surfaces facing upward (that is, excluding the sheet feeding trays in which sheets are set with the printing surfaces facing downward) are displayed (presented) as options in a selectable manner. In the example of the MFP 100, the external sheet feeding deck 210 and the manual sheet feeding tray 211 will be selectable targets.

If it has been determined in step S806 that the printing surfaces of the discharged sheets do not face upward, the processing proceeds to step S808. In step S808, setting is performed such that only sheet feeding trays in which sheets are set with the printing surfaces facing downward are displayed in a selectable manner. In the example of the MFP 100, the sheet feeding cassettes 206 to 209 will be selectable targets.

Thereafter, if the user presses the “Sheet Feeding Selection 2” button in the print setting screen 601 shown in FIG. 6, a UI screen as shown in FIG. 10C is displayed in step S809, with only the sheet feeding trays that have been set in one of the steps S805, S807, and S808 being displayed in a selectable manner. That is, based on the determination result in step S806, only feeding units are specified with which if discharged sheets are contained without the front and back surfaces of the sheets being inverted, image formation is performed on the same surface as that on which images have been formed. Then, only the specified feeding units are presented to the user as options for the feeding unit to be used in the image forming processing using the transparent toner (second toner) (presentation processing). Then, information on the feeding unit that has been selected by the user from among the feeding units displayed in the UI screen is set as “Sheet Feeding Selection 2”. After all of the above finishing settings are complete, the processing proceeds to step S810, where the processing ends.

Here, buttons 1201 to 1206 that correspond to the respective feeding units provided in the MFP 100 are displayed in a screen 1200 in FIG. 100. For example, the buttons 1201 to 1204 correspond respectively to the sheet feeding cassettes 206 to 209, the button. 1205 corresponds to the sheet feeding deck 210, and the button 1206 corresponds to the manual sheet feeding tray 211.

Next, a processing flow of the print processing will be described with reference to FIG. 9. The print processing is started in step S901. In step S902, the CPU 412 executes print processing on a sheet using color toner of four colors including C, M, Y, and K, as the first image forming processing. When the print processing has ended, the processing proceeds to step S903.

In step S903, the CPU 412 displays, for example, an instruction screen 1000 in FIG. 10A in the operation unit 140 in order to instruct the user to contain sheets that have undergone the print processing in step S902 in the feeding unit designated by the user in step S809 in FIG. 8. In FIG. 10A, buttons 1001 to 1004 correspond respectively to the sheet feeding cassettes 206 to 209, the button 1005 corresponds to the sheet feeding deck 210, and the button 1006 corresponds to the manual sheet feeding tray 211.

Here, the CPU 412 performs displaying in an easy-to-understand manner by, for example, causing the display of feeding-unit buttons presented to the user to flash. As a result, the user can easily confirm to which feeding unit he/she should contain the sheets on which images have been formed by the first image forming processing. For example, a long time is required from the start to completion of the first image forming processing if a large number of pages are to be processed in the first image forming processing. The display as shown in FIG. 10A is, in particular, effective in such a case. This is because the user can easily recognize to which feeding unit he/she should contain the sheets on which images have been formed by the first image forming processing, by just looking at the display without memorizing it.

Furthermore, in step S904, the CPU 412 causes the MFP 100 to transition to a state in which the MFP 100 stands by for sheet feeding, and thereafter the processing proceeds to step S905. Note that in step S904, the CPU 412 loads information on the print job into the HDD 150. As a result, the CPU 412 can execute the loaded print job after sheets have been set in the designated feeding unit for the second image forming processing of the print job.

In step S905, the CPU 412 determines whether or not sheets are contained in the designated feeding unit. For example, if an open/close detection sensor provided in each of the sheet feeding cassettes 206 to 209 and the sheet feeding deck 210 has detected the opening and subsequent re-closing of the cassette or the deck, the CPU 412 determines that sheets are contained in the feeding unit. As for the manual sheet feeding tray 211, if a sheet detection sensor provided in the manual sheet feeding tray 211 has detected the presence of sheets, the CPU 412 determines that the sheets are contained in the feeding unit.

if the sheets are not contained in step S905, the processing proceeds to step S904. Upon determining that the sheets are contained in step S905, the CPU 412 proceeds the processing to step S906. The CPU 412 cancels the sheet feeding standby state in step S906, and executes image print processing on the sheets using the transparent toner (CL), as the second image forming processing, in step S907.

Note that the present embodiment describes an example of control in which the CPU 412 automatically executes the second image forming processing upon determining that sheets are contained. However, the present invention is not limited thereto, and in step S907, the CPU 412 may start the second image forming processing upon detecting that a start button provided in the operation unit 140 has been pressed by the user.

Then, after the print processing in step S907 has ended, the CPU 412 discharges the sheets to the discharge unit, and the series of processes ends in step S908.

As described above, with the image forming apparatus according to the present embodiment, the following effect can be achieved. That is, it is possible to prevent erroneous settings at the time of performing sheet re-feed setting in accordance with the print settings in the case of executing the second image forming processing on the sheets that have undergone the first image forming processing

Note that in the present embodiment, it is also possible to restrict sheet feeding for other image forming processing that is different from the second image forming processing, because there is the possibility that the sheets re-set in a feeding unit will be used during execution of other lobs that may be performed between the first image forming processing and the second image forming processing. Furthermore, it is also possible to divide output sheets by the number of sheets that can be re-set (contained) in a feeding unit for the second image forming processing, by means such as switching of discharge trays for each set of sheets output by the first image forming processing, shift sheet discharging, or use of interleaved sheets. The term “shift sheet discharging” as used herein refers to discharging sheets by shifting the position of sheet discharging every fixed number of sheets.

### Second Embodiment

A second embodiment mainly differs from the first embodiment in the following points: (1) a print instruction to perform single-side printing or double-side printing on a plurality of pages in numerical order; (2) a sheet setting method to be used when performing second or subsequent sheet discharging output/sheet re-feeding using transparent toner; and (3) determination processing for inverting the fronts and backs of discharge surfaces by performing inverted output.

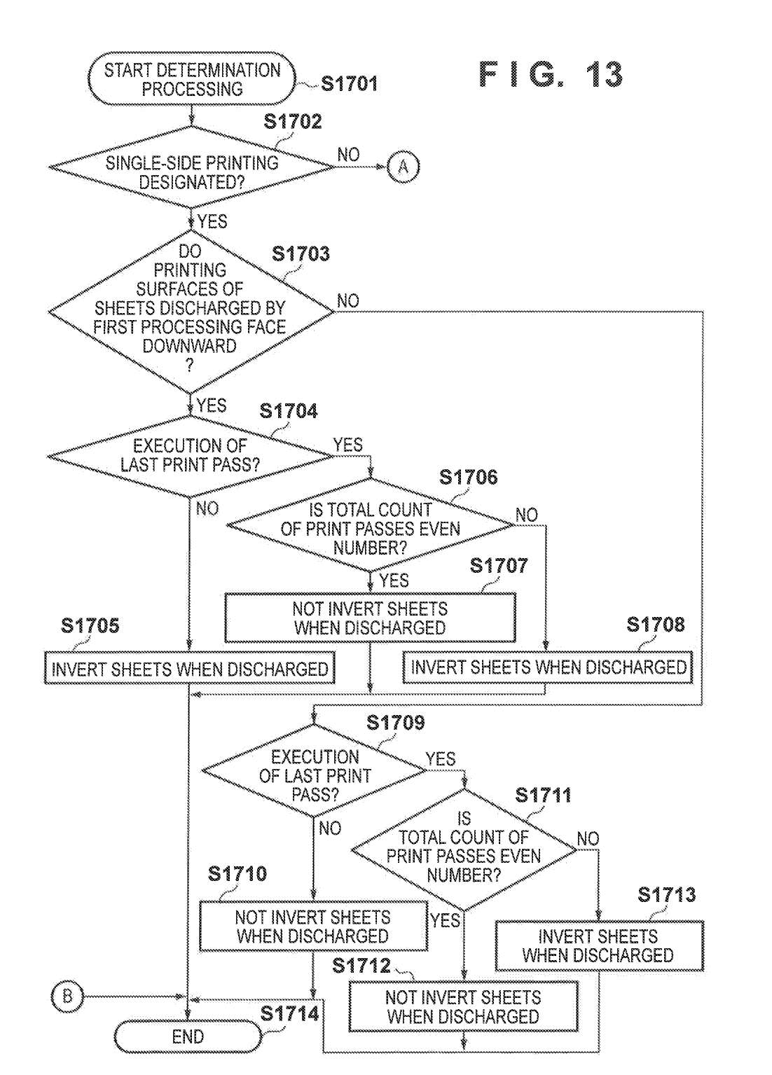

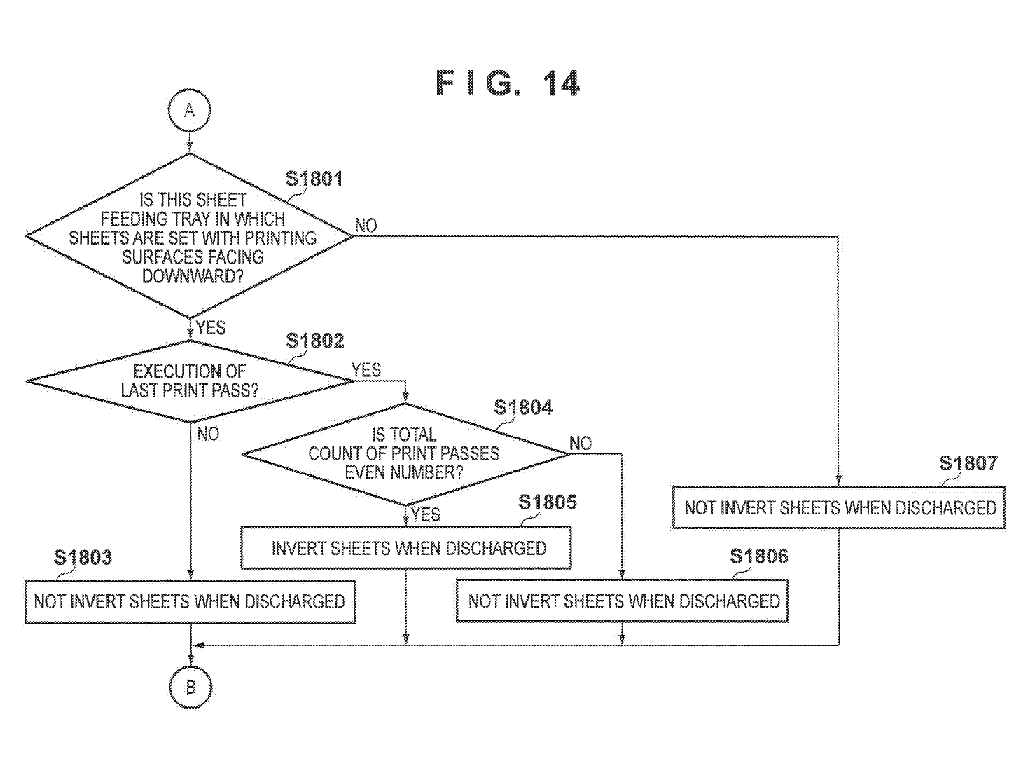

FIGS. 13 and 14 are diagrams showing processing flows according to the present embodiment. In step S1701, the CPU 412 starts determination processing for determining whether or not inversion for inverting the fronts and backs of sheets at the time of sheet discharging is necessary. In step S1702, the CPU 412 determines whether or not single-side printing has been designated in the print setting 605 of the print setting screen 601 in FIG. 6.

A processing flow performed in the case where single-side printing has not been designated (that is, in the case of double-side printing) will be discussed later with reference to FIG. 14. If the CPU 412 has determined in step S1702 that single-side printing had been designated, the processing proceeds to step S1703, where it is determined whether or not it is the sheet feeding tray in which sheets are set in the feeding unit with the printing surfaces facing downward.

If the CPU 412 has determined in step S1703 that it is the sheet feeding tray in which sheets are set with the printing surfaces facing downward, the processing proceeds to step S1704, and otherwise the processing proceeds to step S1709. In step S1704, the CPU 412 determines whether or not it is the execution of the last print pass. The determination as to whether or not it is the execution of the last print pass is performed by the CPU 412 based on the repetition count for the second image forming processing, which has been set in the setting item 607.

If the CPU 412 has determined in step S1704 that it is not the execution of the last print pass, the processing proceeds to step S1705, and otherwise the processing proceeds to step S1706. In step S1705, the CPU 412 decides to perform inverted output at the time of sheet discharging and thereafter the processing proceeds to step S1714, where the determination processing ends.

In step S1706, the CPU 412 determines whether or not a total count of print passes to be executed is an even number, based on the repetition count for the second image forming processing, which has been set in the setting item 607 of the print setting screen 601 in FIG. 6. If the CPU 412 has determined that the total count is an even number, the processing proceeds to step S1707, and otherwise the processing proceeds to step S1708. In step S1707, the CPU 412 decides not to perform inverted output at the time of sheet discharging and thereafter the processing proceeds to step S1714, where the determination processing ends. In step S1708, the CPU 412 decides to perform inverted output at the time of sheet discharging and thereafter the processing proceeds to step S1714, where the determination processing ends.

In step S1709, the CPU 412 determines whether or not it is the execution of the last print pass. The determination as to whether or not it is the execution of the last print pass is performed by the CPU 412 based on the repetition count for the second image forming processing, which has been set in the setting item 607. If the CPU 412 has determined in step S1709 that it is not the execution of the last print pass, the processing proceeds to step S1710, and otherwise the processing proceeds to step S1711. In step S1710, the CPU 412 decides not to perform inverted output at the time of sheet discharging and thereafter the processing proceeds to step S1714, where the determination processing ends.

In step S1711, the CPU 412 determines whether or not the total count of print passes to be executed is an even number, based on the repetition count for the second image forming processing, which has been set in the setting item 607 of the print setting screen 601 in FIG. 6. If the CPU 412 has determined that the total count is an even number, the processing proceeds to step S1712, and otherwise the processing proceeds to step S1713. In step S1712, the CPU 412 decides not to perform inverted output at the time of sheet discharging and thereafter the processing proceeds to step S1714, where the determination processing ends. In step S1713, the CPU 412 decides to perform inverted output at the time of sheet discharging and thereafter the processing proceeds to step S1714, where the determination processing ends.

Then, a description of FIG. 14 will be given. The processing shown herein is processing performed in the case where the determination in step 31702 in FIG. 13 shows that single-side printing has not been designated in the print setting 605 of the print setting screen 601 in FIG. 6 (that is, in the case where double-side printing has been designated).

First, in step S1801, the CPU 412 determines whether or not it is the sheet feeding tray in which sheets are set with the printing surfaces facing downward. If it has been determined that it is the sheet feeding tray in which sheets are set with the printing surfaces facing downward, the processing proceeds to step S1802, and otherwise the processing proceeds to step S1807.

In step S1802, the CPU 412 determines whether or not: it is the execution of the last print pass. The determination as to whether or not it is the execution of the last print pass is performed by the CPU 412 based on the repetition count for the second image forming processing, which has been set in the setting item 607 of the print setting screen 601 in FIG. 6. If the CPU 412 has determined in step S1802 that it is not the execution of the last print pass, the processing proceeds to step S1803, and otherwise the processing proceeds to step S1804. In step S1803, the CPU 412 decides not to perform inverted output at the time of sheet discharging and thereafter the processing proceeds to step S1714, where the determination processing ends.

In step S1804, the CPU 412 determines whether or not the total count of print passes to be executed is an even number, based on the repetition count for the second image forming processing, which has been set in the setting item 607 of the print setting screen 601 in FIG. 6. If the CPU 412 has determined that the total count is an even number, the processing proceeds to step S1805, and otherwise the processing proceeds to step S1806. In step S1805, the CPU 412 decides to perform inverted output at the time of sheet discharging and thereafter the processing proceeds to step S1714, where the determination processing ends. In step S1806, the CPU 412 decides not to perform inverted output at the time of sheet discharging and thereafter the processing proceeds to the step S1714, where the determination processing ends. In step S1807, the CPU 412 decides not to perform inverted output at the time of sheet discharging and thereafter the processing proceeds to step S1714, where the determination processing ends.

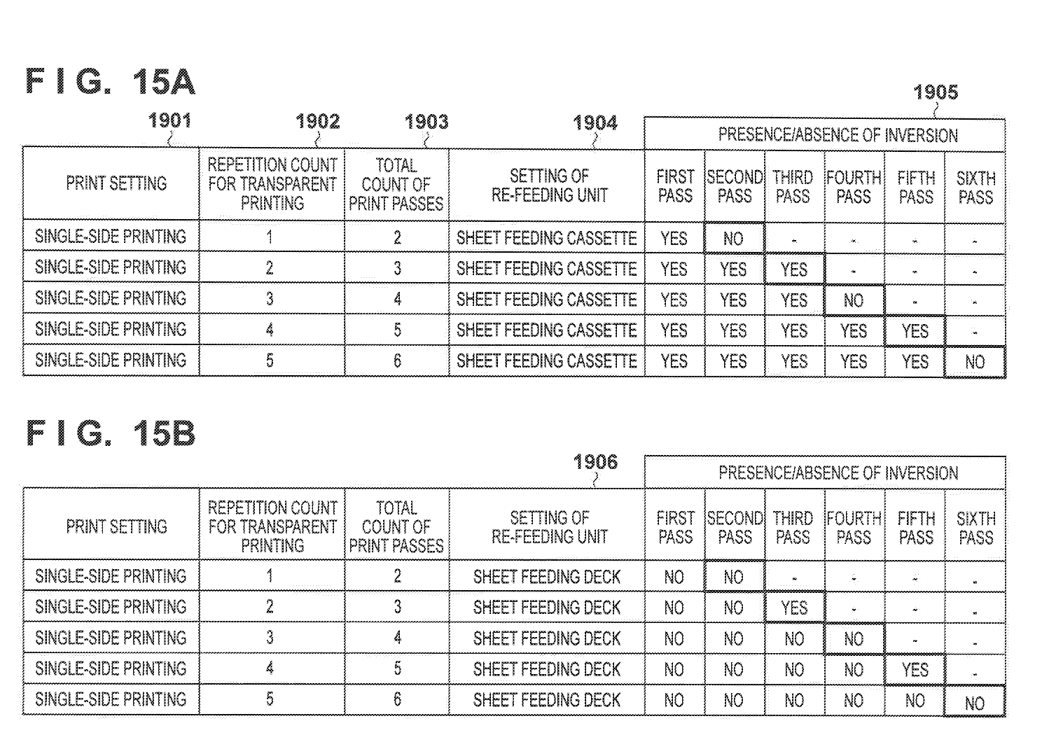

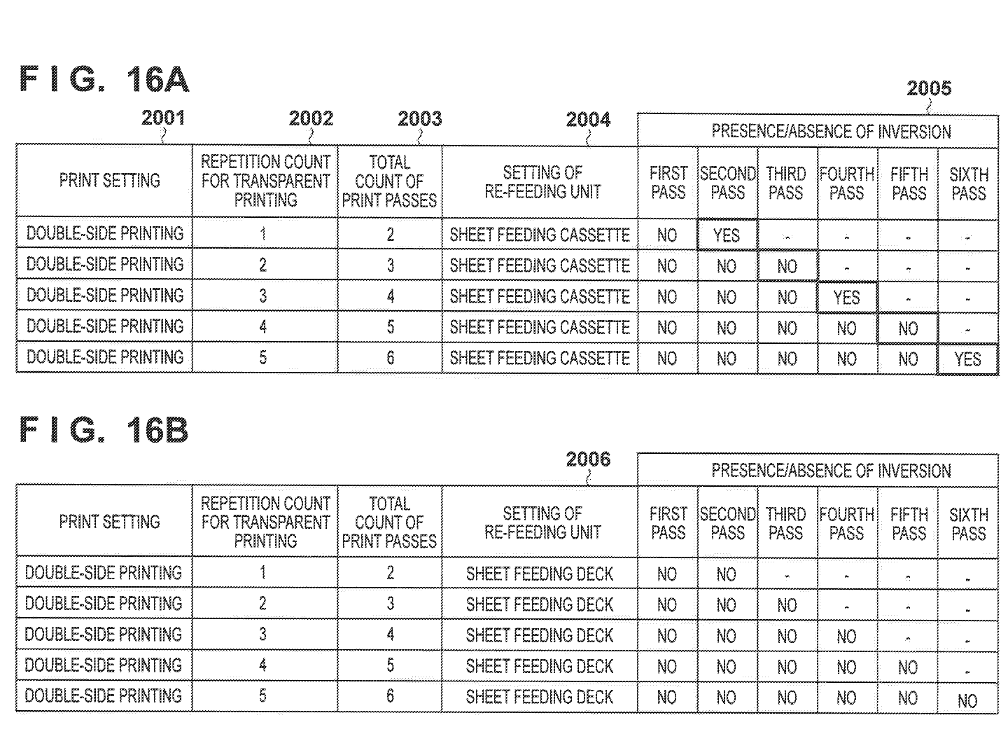

FIGS. 15A, 15B, 16A, and 16B are diagrams showing examples of a table for storing various types of print setting data designated by users in the print setting screen. 601 in FIG. 6.

First, FIGS. 15A and 15B will he described. An item field 1901 indicates whether single-side printing or double-side printing has been designated in the print setting 605 of the print setting screen 601. An item field 1902 indicates the repetition count for the second image forming processing, which has been designated in the setting item 607 of the print setting screen 601. An item field 1903 indicates the total number of print passes including the first image forming processing, taking into consideration the repetition count for the second image forming processing, which has been designated in the setting item 607.

An item field 1904 indicates which one of the sheet feeding cassettes 206 to 209, the sheet feeding deck 210, and the manual sheet feeding tray 211 has been designated as the feeding unit in the setting item 609 of the print setting screen 601. An item field 1905 indicates whether or not inverted output is necessary in accordance with the total count for each print pass. Referring to the item field 1904, the presence or absence of inversion is indicated on the basis of the sheet feeding cassette by focusing on single-side printing and the repetition count for the second image forming processing. Referring to an item field 1906, the presence or absence of inversion is indicated on the basis of the external sheet feeding deck by focusing on single-side printing and the repetition count for the second image forming processing.

Next, FIGS. 16A and 16B will be described. An item field 2001 indicates whether single-side printing or double-side printing has been designated in the print setting 605. An item field 2002 indicates the repetition count for the second image forming processing, which has been designated in the setting item 607. An item field 2003 indicates the total number of print passes including the first image forming processing, taking into consideration the repetition count for the second image forming processing, which has been designated in the setting item 607. An item field 2004 indicates which one of the sheet feeding cassettes 206 to 209, the sheet feeding deck 210, and the manual sheet feeding tray 211 has been set in the sheet feeding selection in the setting item 609. An item field 2005 indicates whether or not inverted output is necessary in accordance with the total count for each print pass. Referring to the item field 2004, the presence or absence of inversion is indicated on the basis of the sheet feeding cassette by focusing on double-side printing and the repetition count for the second image forming processing. Referring to an item field 2006, the presence or absence of inversion is indicated on the basis of the external sheet feeding deck by focusing on double-side printing and the repetition count for the second image forming processing.

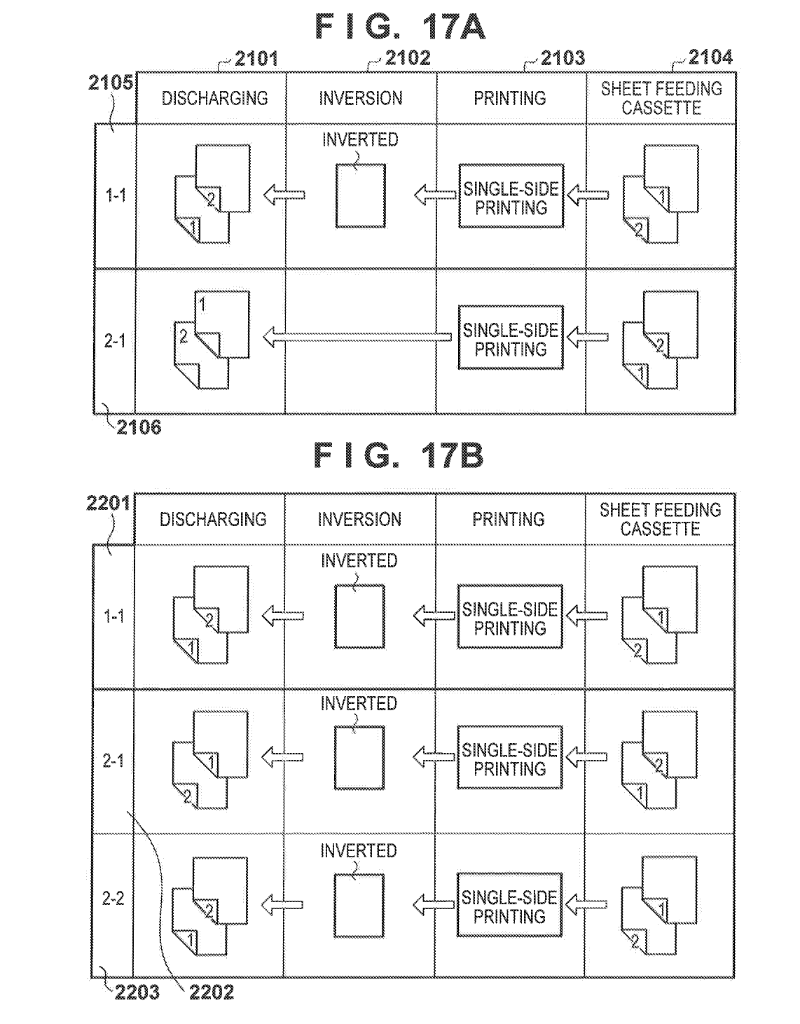

In order to facilitate understanding of the above descriptions of FIGS. 15A, 15B, 16A, and 16B, a further detailed description is given with reference to FIGS. 17A through 24. In FIG. 17A, an item field 2101 schematically indicates the printing surfaces of sheets when discharged. An item field 2102 indicates whether or not the fronts and backs of the sheets are to be inverted at the time of sheet discharging to the face-up discharge opening 317. An item field 2103 is for distinguishing between single-side print processing and double-side print processing. If double-side printing is indicated in the item field 2103, it means that the sheets that have undergone double-side printing are transferred to the item field 2102. An item field 2104 indicates the type of the feeding unit to be used in the MFP 100 of the present emboddment. Data 2105 schematically indicates the correspondence between the flow of sheets and the printing surfaces of the sheets when the first image forming processing has been performed. Data 2106 schematically indicates the correspondence between the flow of sheets and the printing surfaces of the sheets when the second image forming processing has been performed.

In FIG. 17B, data 2201 schematically indicates the correspondence between the flow of sheets and the printing surfaces of the sheets when the first image forming processing has been performed. Data 2202 schematically indicates the correspondence between the flow of sheets and the printing surfaces of the sheets when the second image forming processing has been performed for the first time Data 2203 schematically indicates the correspondence between the flow of sheets and the printing surfaces of the sheets when the second image forming processing has been performed a second time.

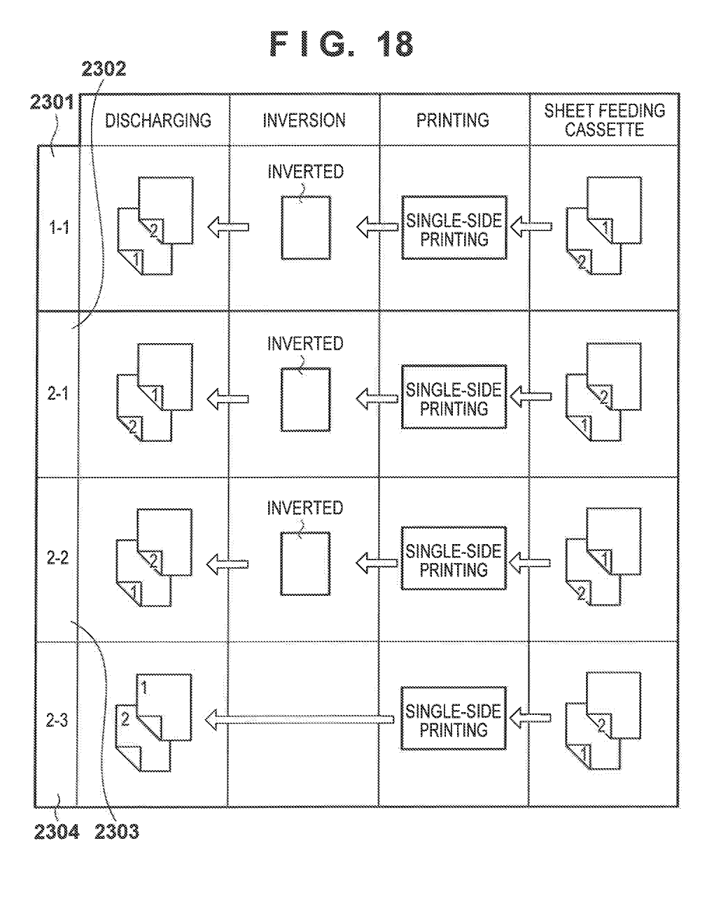

In FIG. 18, data 2301 schematically indicates the correspondence between the flow of sheets and the printing surfaces of the sheets when the first image forming processing has been performed. Data 2302 schematically indicates the correspondence between the flow of sheets and the printing surfaces of the sheets when the second image forming processing has been performed for the first time. Data 2303 schematically indicates the correspondence between the flow of sheets and the printing surfaces of the sheets when the second image forming processing has been performed a second time. Data 2304 schematically indicates the correspondence between the flow of sheets and the printing surfaces of the sheets when the second image forming processing has been performed a third time.

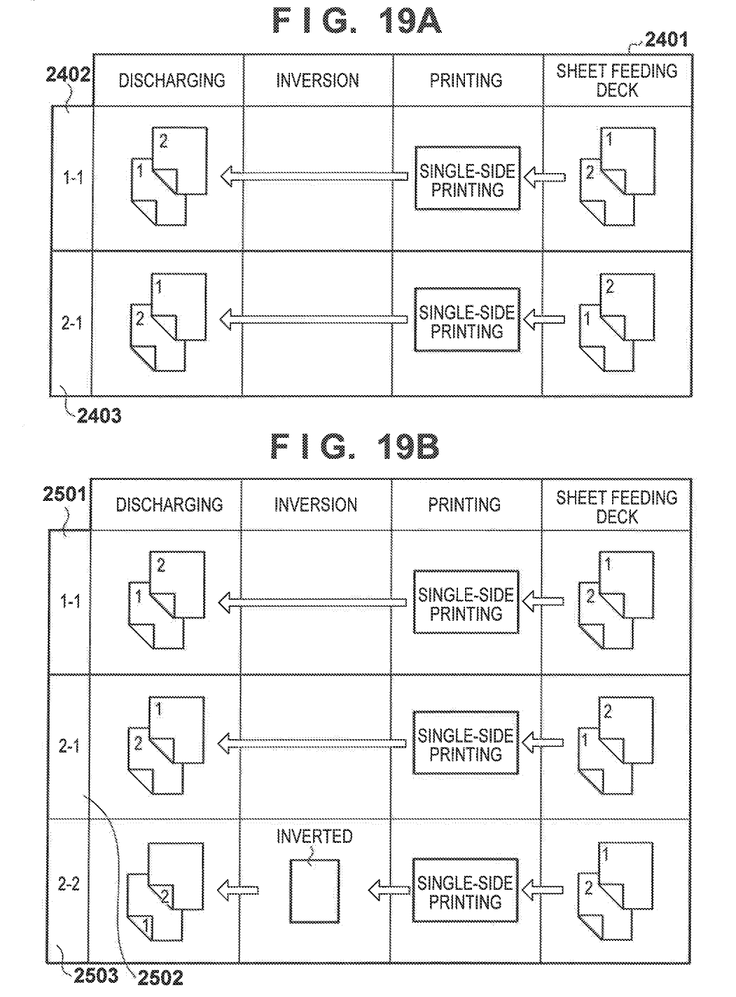

In FIG. 19A, an item field 2401 indicates a different feeding unit to be used, as compared with FIG, 17A. Data 2402 schematically indicates the correspondence between the flow of sheets and the printing surfaces of the sheets when the first image forming processing has been performed. Data 2403 schematically indicates the correspondence between the flow of sheets and the printing surfaces of the sheets when the second image forming processing has been performed.

In FIG. 19B, data 2501 schematically indicates the correspondence between the flow of sheets and the printing surfaces of the sheets when the first image forming processing has been performed. Data 2502 schematically indicates the correspondence between the flow of sheets and the printing surfaces of the sheets when the second image forming processing has been performed for the first time. Data 2503 schematically indicates the correspondence between the flow of sheets and the printing surfaces of the sheets when the second image forming processing has been performed a second time.

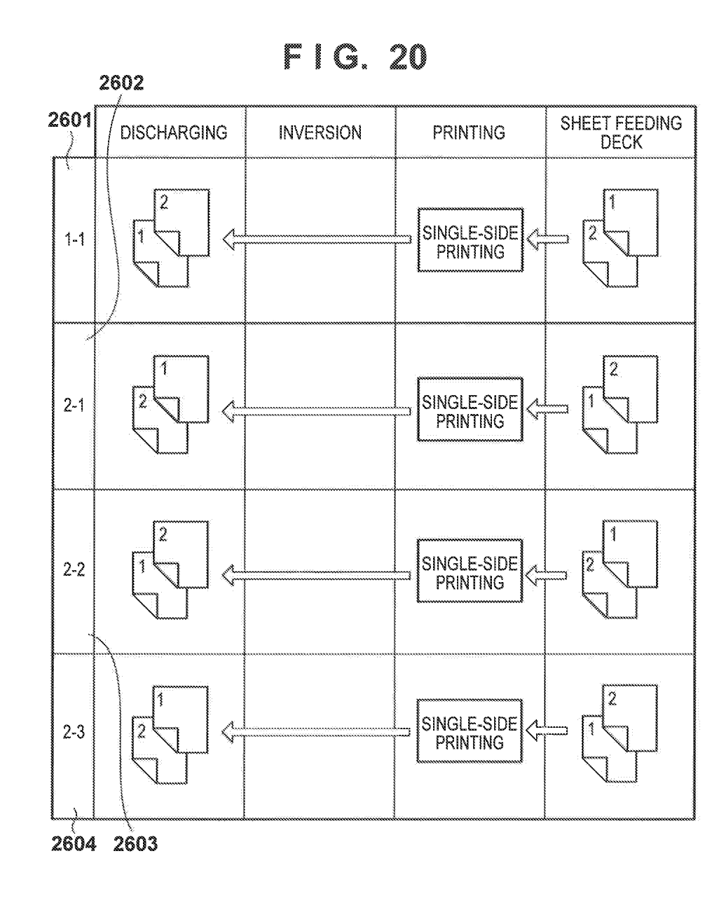

In FIG. 20, data 2601 schematically indicates the correspondence between the flow of sheets and the printing surfaces of the sheets when the first image forming processing has been performed. Data 2602 schematically indicates the correspondence between the flow of sheets and the printing surfaces of the sheets when the second image forming processing has been performed for the first time. Data 2603 schematically indicates the correspondence between the flow of sheets and the printing surfaces of the sheets when the second image forming processing has been performed a second time. Data 2604 schematically indicates the correspondence between the flow of sheets and the printing surfaces of the sheets when the second image forming processing has been performed a third time.

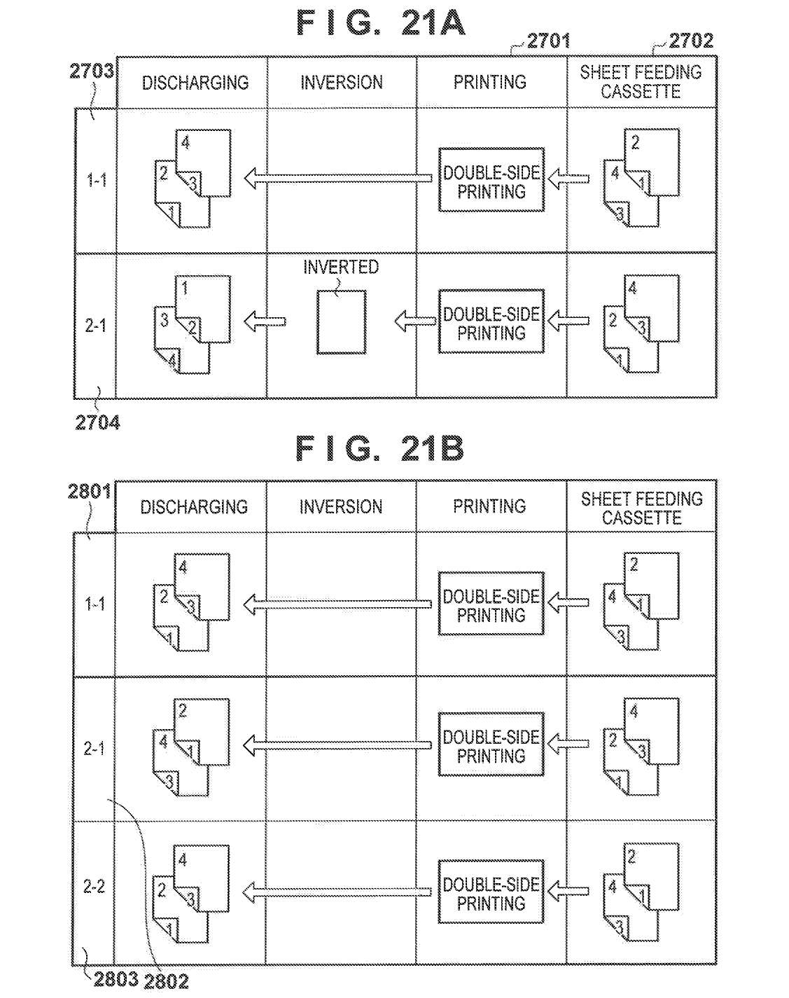

In FIG. 21A, an item field 2701 indicates a different printer unit to be used, as compared with FIG. 17A. An item field 2702 indicates a different feeding unit to be used, as compared with FIG. 17A. Data 2703 schematically indicates the correspondence between the flow of sheets and the printing surfaces of the sheets when the first image forming processing has been performed. Data 2704 schematically indicates the correspondence between the flow of sheets and the printing surfaces of the sheets when the second image forming processing has been performed.

In FIG. 21B, data 2801 schematically indicates the correspondence between the flow of sheets and the printing surfaces of the sheets when the first image forming processing has been performed. Data 2802 schematically indicates the correspondence between the flow of sheets and the printing surfaces of the sheets when the second image forming processing has been performed for the first time. Data 2803 schematically indicates the correspondence between the flow of sheets and the printing surfaces of the sheets when the second image forming processing has been performed a second time.

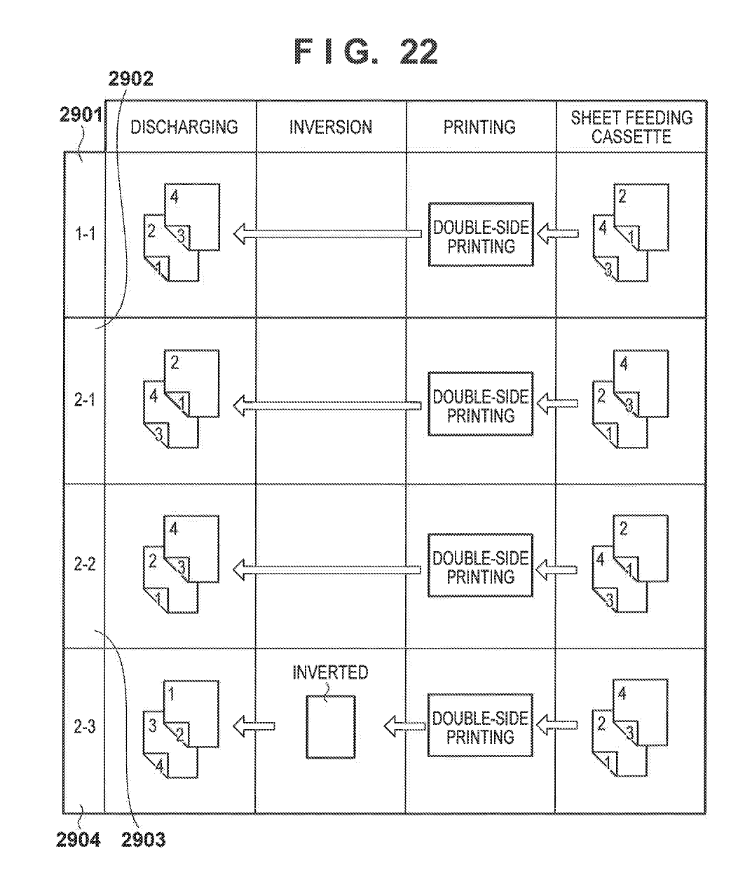

in FIG. 22, data 2901 schematically indicates the correspondence between the flow of sheets and the printing surfaces of the sheets when the first image forming processing has been performed. Data 2902 schematically indicates the correspondence between the flow of sheets and the printing surfaces of the sheets when the second image forming processing has been performed for the first time. Data 2903 schematically indicates the correspondence between the flow of sheets and the printing surfaces of the sheets when the second image forming processing has been performed a second time. Data 2904 schematically indicates the correspondence between the flow of sheets and the printing surfaces of the sheets when the second image forming processing has been performed a third time.

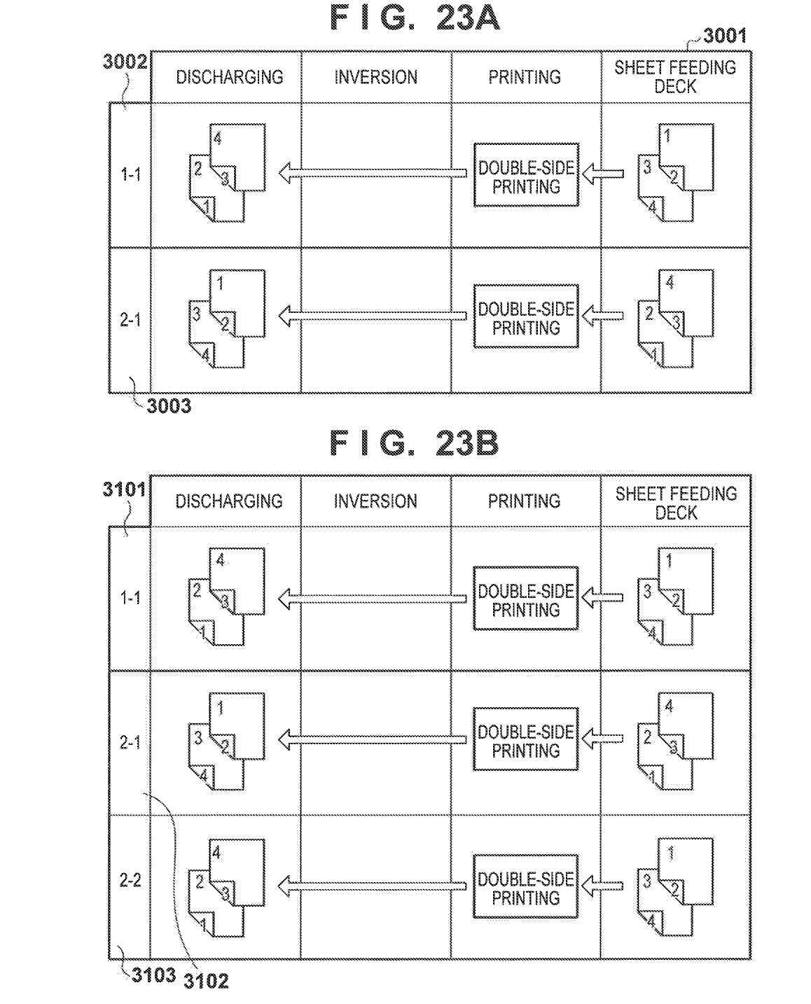

In FIG. 23A, an item field 3001 indicates a different feeding unit to be used, as compared with FIG. 21A. Data 3002 schematically indicates the correspondence between the flow of sheets and the printing surfaces of the sheets when the first image forming processing has been performed. Data 3003 schematically indicates the correspondence between the flow of sheets and the printing surfaces of the sheets when the second image forming processing has been performed.

In FIG. 23B, data 3101 schematically indicates the correspondence between the flow of sheets and the printing surfaces of the sheets when the first image forming processing has been performed. Data 3102 schematically indicates the correspondence between the flow of sheets and the printing surfaces of the sheets when the second image forming processing has been performed for the first time. Data 3103 schematically indicates the correspondence between the flow of sheets and the printing surfaces of the sheets when the second image forming processing has been performed a second time.

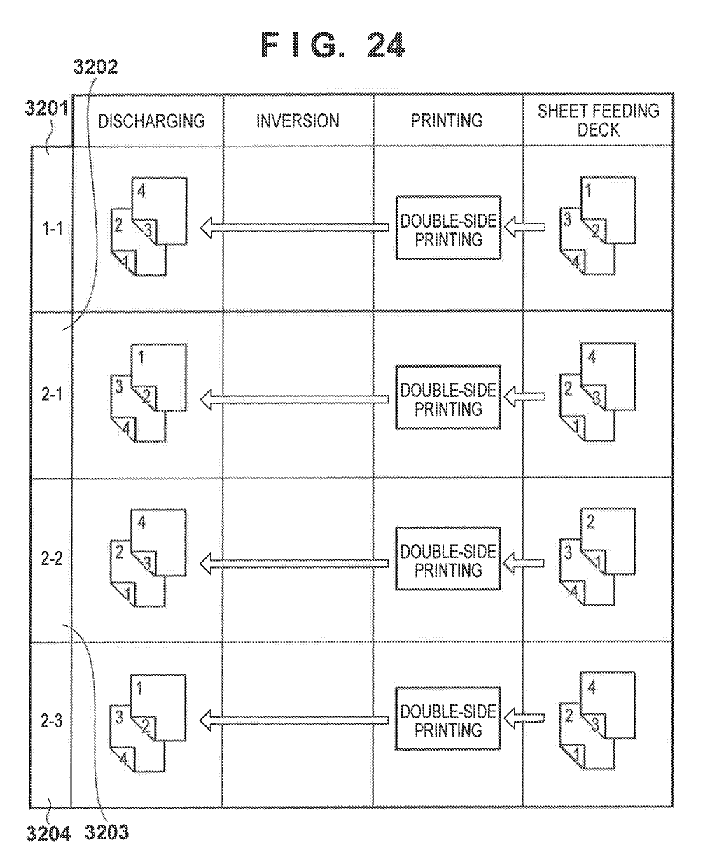

In FIG. 24, data 3201 schematically indicates the correspondence between the flow of sheets and the printing surfaces of the sheets when the first image forming processing has been performed. Data 3202 schematically indicates the correspondence between the flow of sheets and the printing surfaces of the sheets when the second image forming processing has been performed for the first time. Data 3203 schematically indicates the correspondence between the flow of sheets and the printing surfaces of the sheets when the second image forming processing has been performed a second time. Data 3204 schematically indicates the correspondence between the flow of sheets and the printing surfaces of the sheets when the second image forming processing has been performed a third time.

As described above, with the image forming apparatus according to the present embodiment, the following effects can be achieved. That is, it is possible to prevent erroneous settings at the time of performing sheet re-feeding setting in accordance with the print settings in the case of executing the second image forming processing on sheets that have undergone the first image forming processing. Furthermore, even for a printing original having pages in numerical order, it is possible to produce a final output that keeps the order.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-025337 filed on Feb. 8, 2011, which is hereby incorporated by reference herein in its entirety.

What is claimed is:

1. An image forming apparatus that, forms an image on a sheet conveyed from any one of a plurality of sheet-containing units, comprising:
an image forming unit configured to form an image using a first printing material on a first surface of the sheet: conveyed from the sheet-containing unit and discharges the sheet on which the image has been formed;
a specification unit configured to specify a sheet-containing unit with which, if the sheet discharged to a discharge unit is contained without the first surface and a second surface of the sheet being inverted, image formation is performed on the first surface on which the image has been formed; and
a notification unit configured to notify a user of the sheet-containing unit specified by the specification unit as a sheet-containing unit to be used in image forming processing using a second printing material.

2. The image forming apparatus according to claim 1, further comprising:
a judgment unit configured to judge whether the sheet on which the image has been formed is set to be discharged with the first surface facing upward or the sheet is set to be discharged with the second surface facing upward,
wherein the specification unit specifies, in accordance with the judgment by the judgment unit, a sheet-containing unit with which, if the sheet discharged to the discharge unit is contained without the first surface and the second surface of the sheet being inverted, image formation is performed on the first surface on which the image has been formed.

3. The image forming apparatus according to claim 1, further comprising:
a determination unit configured to determine whether setting is configured so as to form an image on the first surface of the sheet or to form images on the first surface and the second surface of the sheet,
wherein if the determination unit determines that the setting is configured so as to form an image on the first surface of the sheet, the specification by the specification unit and the notification by the notification unit are performed.

4. The image forming apparatus according to claim 3 wherein in a case where the determination unit determines that setting is configured so as to form images on the first surface and the second surface of the sheet, the notification unit notifies the user of all of the plurality of sheet-containing units as sheet-containing units usable in second image forming processing.

5. The image forming apparatus according to claim 1, wherein the plurality of sheet-containing units include a first sheet-containing unit with which a sheet is not inverted prior to the image formation, and a second sheet-containing unit with which a sheet is inverted prior to the image formation.

6. The image forming apparatus according to claim 1, further comprising:
a detection unit configured to detect that a sheet has been contained in the sheet-containing unit notified by the notification unit,
wherein in a case where the detection unit detects that a sheet has been contained, the image forming unit starts the image forming processing using the second printing material on the sheet conveyed from the sheet-containing unit notified by the notification unit.

7. A control method for an image forming apparatus that forms an image on a sheet conveyed from any one of a plurality of sheet-containing units, the method comprising:
forming an image using a first printing material on a first surface of the sheet conveyed from the sheet-containing unit and discharging the sheet on which the image has been formed;
specifying a sheet-containing unit with which, if the sheet discharged to a discharge unit is contained without the first surface and a second surface of the sheet being inverted, image formation is performed on the first surface on which the image has been formed; and
notifying a user of the sheet-containing unit specified in the specification step as a sheet-containing unit to be used in image forming processing using a second printing material.

8. A computer-readable storage medium storing a computer program for causing a computer to execute the steps of the control method of claim 7.
